(19) United States
(12) Patent Application Publication
(10) Pub. No.: US 2020/0305232 A1
(43) Pub. Date: Sep. 24, 2020

(54) Apparatuses, Methods And Computer Programs For A Base Station Transceiver, A User Equipment And An Entity Of A Mobile Communication System

(71) Applicant: Apple Inc., Cupertino, CA (US)

(72) Inventor: Honglei Miao, Munich (DE)

(21) Appl. No.: 16/640,273

(22) PCT Filed: Aug. 14, 2018
(86) PCT No.: PCT/US2018/046593

§ 371 Date: Feb. 19, 2020

Related U.S. Application Data
(60) Provisional application No. 62/551,566, filed on Aug. 29, 2017.

(51) Int. Cl. H04W 88/10; H04L 5/00; H04W 72/04; H04L 27/26; H04W 68/00; H04B 1/38

(52) U.S. Cl. CPC H04W 88/10; H04L 5/005; H04L 5/0051; H04B 1/38; H04L 27/2613; H04W 68/005; H04W 72/042

(57) ABSTRACT

An apparatus for a base station transceiver of a mobile communication system includes at least one interface for communicating with a transceiver module of the base station trans¬ceiver. The apparatus includes a control module configured to provide a reference signal to a user equipment of the mobile communication system via the transceiver module. The reference signal is a reference signal for time tracking. Control module is configured to provide a downlink control signal to the user equipment via the transceiver module. The reference signal and the downlink control signal are quasi-co-located.

### FIELD

Examples relate to an apparatus, a method and a computer program for a base station transceiver, an apparatus a method and a computer program for a user equipment and an apparatus, a method and a computer program for an entity of a mobile communication system.

### BACKGROUND

In mobile communication systems, e.g. in 3GPP 5^{th} generation (5G) networks, a large variety of base station transceivers may be used to communicate with user equipment. Due to a combination of different technologies and frequency bands used and/or due to the use of beam forming technologies with an increased number of heterogeneous base stations, parameters for communicating via a wireless channel between a user equipment and a base station may be continuously adjusted.

### BRIEF DESCRIPTION OF THE FIGURES

Some examples of apparatuses and/or methods will be described in the following by way of example only, and with reference to the accompanying figures, in which

FIG. 1a shows block diagram of an apparatus or a device for a base station transceiver of/for a mobile communication system according to at least some examples;

FIG. 1b shows a flow chart of a method for a base station transceiver of/for a mobile communication system according to at least some examples;

FIG. 2a shows a block diagram of an apparatus or a device for a user equipment of/for a mobile communication system according to at least some examples;

FIG. 2b shows a flow chart of a method for a user equipment of/for a mobile communication system according to at least some examples;

FIG. 3a shows a block diagram of an apparatus or device for an entity of/for a mobile communication system according to at least some examples;

FIG. 3b shows a flow chart of a method for an entity of/for a mobile communication system according to at least some examples;

FIG. 4 shows a schematic diagram of a tracking reference signal;

FIG. 5 shows a schematic diagram of a self-contained control channel with a quasi-co-located TRS configuration according to at least some examples;

FIG. 6 shows a flow chart of a self-contained control channel transmission according to at least some examples;

FIG. 7 illustrates an architecture of a system of a network in accordance with some embodiments;

FIG. 8 illustrates example components of a device in accordance with some embodiments;

FIG. 9 illustrates example interfaces of baseband circuitry in accordance with some embodiments;

FIG. 10 is an illustration of a control plane protocol stack in accordance with some embodiments;

FIG. 11 is an illustration of a user plane protocol stack in accordance with some embodiments;

FIG. 12 illustrates components of a core network in accordance with some embodiments;

FIG. 13 is a block diagram illustrating components, according to some example embodiments, of a system to support NFV;

FIG. 14 is a block diagram illustrating components, according to some example embodiments, able to read instructions from a machine-readable or computer-readable medium and perform any one or more of the methodologies discussed herein; and

FIG. 15 illustrates an architecture of a system of a network in accordance with some embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

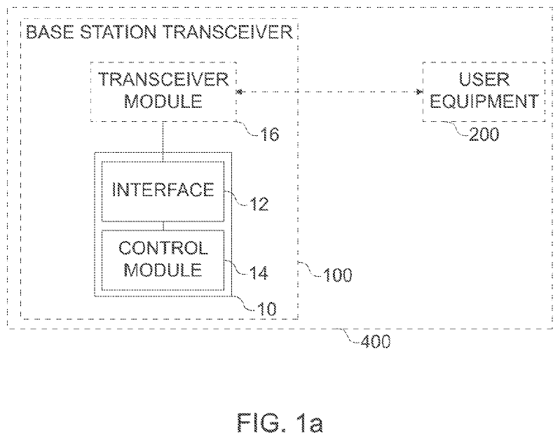

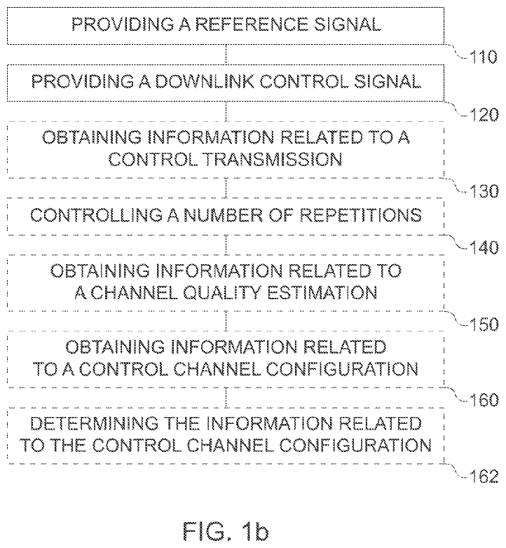

FIG. 1a shows block diagram of an apparatus 10 or a device 10 (denoted “base station transceiver apparatus” or “base station transceiver device”) for a base station transceiver 100 of/for a mobile communication system 400 according to at least some examples. The components of the base station transceiver device 10 are defined as component means, which correspond to the respective structural components of the base station transceiver apparatus 10. The base station transceiver apparatus 10 comprise at least one interface 12 (or a means for communicating 12 of the base station transceiver device 10) for communicating with a transceiver module 16 (or means for transceiving 16) of the base station transceiver 100. The base station transceiver apparatus 10 comprise a control module 14 (or means for controlling 14 of the base station transceiver device 10) configured to provide a reference signal to a user equipment 200 of the mobile communication system 400 via the transceiver module 16. The reference signal is a reference signal for time tracking. The control module 14 is configured to provide a downlink control signal to the user equipment 200 via the transceiver module 16. The reference signal and the downlink control signal are quasi-co-located. The control module 14 is coupled to the at least one interface 12. The at least one interface 12 is coupled to the transceiver module 16. FIG. 1a further shows the base station transceiver 100, e.g. a gNodeB 100, comprising the apparatus 10. For example, the base station transceiver 100 may be a gNodeB of a 3GPP 5G New Radio mobile communication system. FIG. 1 further shows the mobile communication system 400 comprising the gNodeB 100 and the user equipment 200.

The base station transceiver apparatus 10 may be likewise a circuit, circuitry, a unit, a device, a chip, a semiconductor, or a printed circuit board with electrical components.

In mobile communication systems, e.g. in 3GPP 5^{th} generation (5G) networks, a large variety of base station transceivers may be used to communicate with user equipment, e.g. user equipment 200. As such mobile communication systems often rely on beam forming to achieve higher data transmission speeds, to successfully transmit data between the user equipment 200 and a base station transceiver (e.g. the base station transceiver 100), beam forming parameters may be determined for each base station transceiver wanting to communicate with the user equipment 200. One option may be to automatically determine the beam forming parameters for each base station transceiver in the vicinity of the user equipment 200. This might not be feasible due to the variety among the base station transceivers of the mobile communication system, and may use additional processing, and thus additional energy consumption at the user equipment 200, e.g. as many of the base station transceivers might never be used to communicate with the user equipment 200. At least some examples provide a concept, in which a reference signal is provided to the user equipment 200 by a base station transceiver 100 that intends to transmit a downlink control signal to the user equipment 200. The reference signal is co-located with the downlink control signal, i.e. the reference signal may use the same or very similar spatial resources and/or signal properties as the downlink control signal. In this way, if the mobile communication system (e.g. the mobile communication system 400) decides to use a specific base station transceiver, e.g. a so-called hidden node, for transmitting control instructions to the user equipment 200, the (beam-formed) channel for transmitting the control instructions may be evaluated using the reference signal, which the user equipment 200 may use to decode the downlink control signal comprising the control instructions.

The control module is configured to provide a reference signal to the user equipment 200, wherein the reference signal is a reference signal for time tracking. For example, the control module 14 may be configured to provide the reference signal to the transceiver module 16 for transmission to the user equipment 200. For example, the reference signal may be provided from the base station transceiver 100 to the user equipment 200 to enable the user equipment 200 to perform timing/frequency correction for the downlink control signal, e.g. for a downlink control channel, such as the Physical Downlink Control Channel (PDCCH). For example, the reference signal may be a user equipment-specific reference signal. If the reference signal is a user equipment-specific reference signal, it may be used to decode a downlink control signal intended for and/or transmitted to the user equipment 200. For example, the reference signal and the downlink control signal may be provided specifically to the user equipment 200, e.g. using beam forming. For example, the reference signal may be a beam-formed reference signal. The downlink control signal may be a beam-formed downlink control signal. Using a beam-formed reference signal may enable providing a reference for a beam-formed downlink control signal. For example, the reference signal may be a tracking reference signal (TRS). The tracking reference signal may be used to further aide in the decoding of the downlink control signal. In various examples, the reference signal is an aperiodic reference signal. If the reference signal is an aperiodic reference signal, the amount of processing used by a user equipment may be reduced to the instances, in which the aperiodic reference signal is actually transmitted. For example, the reference signal may be at least one of an aperiodic beam-formed reference signal, an aperiodic user equipment-specific reference signal, and an aperiodic tracking reference signal.

The control module 14 is configured to provide the downlink control signal to the user equipment 200 via the transceiver module 16. For example, the control module 14 may be configured to provide the downlink control signal to the transceiver module 16 for transmission to the user equipment 200. For example, the downlink control signal may comprise a control instruction. The downlink control signal may be provided via a downlink control channel, e.g. a physical downlink control channel, PDCCH, of the mobile communication system 400. The PDCCH might be used by base station transceivers that are not synchronized with the user equipment 200 via the synchronization signal block. In general, “downlink” or a “downlink channel” may refer to a channel or directionality from the base station transceiver 100 to the user equipment 200.

In examples, the downlink control signal may comprise one or more control transmissions. For example, the downlink control signal may comprise a paging signal, e.g. a Single Frequency Network (SFN) paging signal, e.g. the paging signal may be transmitted from all the gNodeBs (gNBs) and/or low power nodes in the tracking area of the user equipment (UE) (using the same frequency). If the downlink control signal is a SFN paging signal, the reference signal might also be transmitted as a single frequency network reference signal, e.g. the reference signal may be transmitted from all the gNBs and/or low power nodes in the tracking area of the UE (using the same frequency). A scrambling identifier of the reference signal may be used an identifier of the large single frequency network cell (comprising the tracking area of the user equipment). The one or more control transmissions may be or comprise a paging control transmission. Alternatively, the downlink control signal may comprise a Random Access Response (RAR), e.g. in response to a Random Access Channel (RACH) procedure of the user equipment 200, e.g. in response to a transmission of a random access preamble (e.g. a PRACH (Physical RACH) preamble) of the user equipment 200. The one or more control instructions may be or comprise a random access response control instruction.

The reference signal and the downlink control signal are quasi-co-located. For example, the downlink control signal and the reference signal may be provided/transmitted based on the same spatial filtering parameters (at the base station transceiver 100). The same spatial filtering parameters may be used to achieve quasi-co-located signals. The reference signal and the downlink control signal being quasi-co-located may correspond to the downlink control signal and the reference signal being transmitted based on the same spatial filtering parameters (by the base station transceiver 100). For example, the reference signal and the downlink control signal being quasi-co-located may correspond to the reference signal and the downlink control signal being based on the same beam-forming parameters (at the base station transceiver 100). For example, the control module may be configured to provide the reference signal and the downlink control signal to the user equipment via the transceiver module 16 using the same or (highly) related beam forming parameters and/or using the same spatial filtering parameters.

In at least some examples, the reference signal is an aperiodic reference signal. The control module 14 may be configured to obtain information related a control transmission to be provided to the user equipment 200 using the downlink control signal, e.g. from a further entity of the mobile communication system 400 or by determining the information related to the control transmission to be provided to the user equipment 200 using the downlink control signal. For example, the control module may be configured to detect the transmission of a random access preamble by the user equipment 200 and to determine the information related to the control transmission to be provided to the user equipment 200 using the downlink control signal based on the detected random access preamble. Alternatively or additionally, the control module may be configured obtain information related to a paging control transmission to be transmitted to the user equipment. The information related to the paging control transmission may be or comprise the information related to the control transmission to be provided to the user equipment 200 using the downlink control signal. The aperiodic reference signal may be provided based on the information related to control transmission to be provided to the user equipment 200. For example, the aperiodic reference signal might (only) be provided to the user equipment 200 if a control transmission is to be provided from the base station transceiver 100 to the user equipment 200. The control module 14 may be configured to trigger providing the aperiodic reference signal (only) if a control transmission is to be provided to the user equipment 200. If no control transmission is to be provided from the base station transceiver 100 to the user equipment 200, the control module may be configured to skip (i.e. refrain from) providing the aperiodic reference signal. The control module 14 may be configured to provide the control transmission to the user equipment 200 using the downlink control signal after providing the aperiodic reference signal, e.g. after providing the aperiodic reference signal that is triggered by obtaining the information related to the control transmission to be provided to the user equipment 200 using the downlink control signal. Transmitting the reference signal if a control transmission is to be transmitted to the user equipment using the downlink control signal may enable providing the reference signal from the base station transceiver, that the mobile communication system chooses to transmit the control transmission.

In at least some examples, the control module 14 may be configured to control a number of repetitions of the aperiodic reference signal based on a time elapsed since a previous communication with the user equipment 200. This may enable transmitting the aperiodic reference signal with more repetitions, if a time passed since previous communication between the user equipment and the mobile communication system and/or between the user equipment and the base station transceiver is longer than a time threshold. For example, the control module 14 may be configured to determine the number of repetitions of the aperiodic reference signal based on the time passed since previous communication between the user equipment and the mobile communication system and/or between the user equipment and the base station transceiver. The control module 14 may be configured to determine a first higher number of repetitions of the aperiodic reference signal if the a time passed since previous communication between the user equipment and the mobile communication system and/or between the user equipment and the base station transceiver is longer than a time threshold, and to determine a second lower number of repetitions of the aperiodic reference signal if the a time passed since previous communication between the user equipment and the mobile communication system and/or between the user equipment and the base station transceiver is shorter than a time threshold.

In at least some examples, the control module 14 is configured to obtain information related to a channel quality estimation of a channel between the base station transceiver 100 and the user equipment 200 from the user equipment 200 via the transceiver module 16. For example, the information related to the channel quality estimation may be or comprise a channel quality indicator (CQI) for the channel between the base station transceiver 100 and the user equipment 200. The control module 14 may be configured to control a bandwidth of the reference signal based on the information related to the channel quality estimation. This may enable the base station transceiver apparatus to determine, at which modulation signals may be transmitted to the user equipment, and may thus enable the base station transceiver apparatus to choose the bandwidth for the reference signal accordingly, e.g. to choose a higher bandwidth, if a higher-complexity modulation is used, and to choose a lower bandwidth, if a lower-complexity modulation is used. In this way, the higher bandwidth might (only) be used, if the higher complexity of the modulation warrants the processing resources used for processing the reference signal having a higher bandwidth. For example, the control module 14 may be configured to provide the reference signal using a first larger bandwidth if a quality of the channel quality estimation is above a quality threshold and if a size of a control transmission to be provided using the downlink control signal is above a size threshold. The control module 14 may be configured to provide the reference signal using a second smaller bandwidth if a quality of the channel quality estimation is below the quality threshold or if the size of the control transmission to be provided using the downlink control signal is below the size threshold. This may enable the base station transceiver apparatus to choose the bandwidth for the reference signal accordingly, e.g. to choose a higher bandwidth, if a higher-complexity modulation is used, and to choose a lower bandwidth, if a lower-complexity modulation is used.

In some examples, the control module 14 may be configured to control a bandwidth of the downlink control signal based on the information related to the channel quality estimation. For example, the control module 14 may be configured to provide the downlink control signal using a first larger bandwidth if a quality of the channel quality estimation is above a quality threshold and if a size of a control transmission to be provided using the downlink control signal is above a size threshold. The control module 14 may be configured to provide the downlink control signal using a second smaller bandwidth if a quality of the channel quality estimation is below the quality threshold or if the size of the control transmission to be provided using the downlink control signal is below the size threshold.

For example, the control module 14 may be configured to determine a modulation (e.g. a modulation and coding scheme, MCS) to be used for transmitting the downlink control signal based on the information related to the channel quality estimation. The control module 14 may be configured to choose a first higher bandwidth for the reference signal if a modulation complexity of the modulation to be used for transmitting the downlink control signal is above a modulation complexity threshold, and to choose a second lower bandwidth for the reference signal if a modulation complexity of the modulation to be used for transmitting the downlink control signal is below a modulation complexity threshold. The control module 14 may be configured to choose a first higher bandwidth for the reference signal if a modulation complexity of the modulation to be used for transmitting the downlink control signal is above a modulation complexity threshold and if a size of a control transmission to be provided using the downlink control signal is above a size threshold, and to choose a second lower bandwidth for the reference signal if a modulation complexity of the modulation to be used for transmitting the downlink control signal is below a modulation complexity threshold or if the size of the control transmission to be provided using the downlink control signal is below the size threshold.

In at least some examples, the control module 14 is configured to provide a further reference signal to the user equipment 200 (e.g. via the transceiver module 16). For example, the further reference signal may be a Channel State Information Reference Signal (CSI-RS). Alternatively or additionally, the further reference signal may be or comprise a Synchronization Signal Block (SSB).

In various examples, the control module 14 is configured to provide a demodulation reference signal (DMRS) associated with the downlink control signal to the user equipment 200 (e.g. via the transceiver module 16). The downlink control signal may comprise the demodulation reference signal associated with the downlink control signal.

The downlink control signal may be provided via a (downlink control channel). The properties of the control channel may be defined by a control channel configuration. For example, the control channel configuration may comprise information related to the reference signal. The information related to the control channel configuration may define one or more time-slots for the reference signal (e.g. one or more time-slots before providing the downlink control signal and/or one or more time-slots before a provision of a control resource set for the control channel). The control channel configuration may define the reference signal and the downlink control signal to be quasi-co-located. The control channel configuration may define it to be mandatory that the reference signal and the downlink control signal are quasi-co-located. The control module 14 may be configured to provide the reference signal based on the one or more time slots for the reference signal. If the reference signal is an aperiodic reference signal, the control module 14 may be configured to choose one or a subset of the one or more time slots may be chosen for the reference signal.

The control channel configuration may comprise information related to a time-frequency resource allocation for the reference signal, information related to a reference signal scheduling window and information related to a sequence of the reference signal. The information related to the time-frequency resource allocation for the reference signal may comprise a time duration of the reference signal (e.g. defined in terms of number of slots), a reference signal symbols index within the slot (e.g. in which one or more symbols within a slot may the reference signal be provided), a set of allocated resource blocks for the reference signal, and a set of subcarriers of the reference signal (e.g. the periodicity of the reference signal in a comb structure). The information related to a reference signal scheduling window may comprise information related to a pre-defined number of slots in which the reference signal is allowed to be provided prior to a provision of a control resource set of the control channel. For example, the reference signal may be provided in one or more of the pre-defined number of slots prior to the provision of the control resource set for the control channel. In at least some examples, the pre-defined number of slots may be 1. For example, the reference signal might be allowed to be provided in the slot preceding the provision of the control resource set for the control channel. The information related to the sequence of the reference signal may comprise scrambling identifier of the reference signal sequence.

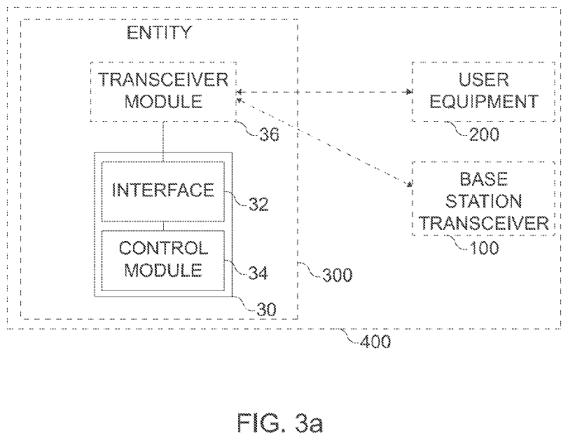

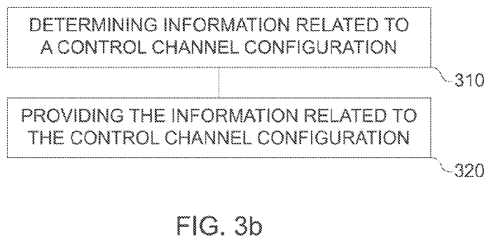

In at least some examples, the control module 14 is configured to obtain the information related to the control channel configuration for the control channel (e.g. a downlink control channel) of the downlink control signal, e.g. from an entity 300 of the mobile communication system 400 (as introduced in connection with FIG. 3a) or by determining the information related to the control channel configuration. The control module 14 may be configured to determine the information related to the control channel configuration. The control module 14 may be configured to provide the information related to the control channel configuration to the user equipment 200. This may enable the base station transceiver to set the control channel configuration for the cell(s) of the mobile communication system associated with the base station transceiver 100. For example, the control module 14 may be configured to provide the information related to the control channel configuration to the user equipment 200 using a radio resource control (RRC) protocol.

In examples, the mobile communication system or network 400 may comprise any Radio Access Technology (RAT). Corresponding transceivers (for example mobile transceivers, user equipment, base stations, relay stations) in the network or system may, for example, operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code Division Multiple Access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Public Land Mobile Telephony), MTD (Swedish abbreviation for Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handyphone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others.

Examples may also be applied to different Single Carrier or OFDM flavors (CP-OFDM, SC-FDMA, SC-OFDM, filter bank-based multicarrier (FBMC), OFDMA) and in particular 3GPP NR (New Radio) by allocating the OFDM carrier data bit vectors to the corresponding symbol resources.

An access node, base station or base station transceiver, e.g. the base station transceiver 100, can be operable to communicate with one or more active user equipment, mobile transceivers or terminals, e.g. the user equipment 200, and a base station transceiver can be located in or adjacent to a coverage area of another base station transceiver, e.g. a macro cell base station transceiver or small cell base station transceiver. Hence, examples may provide a mobile communication system comprising one or more mobile transceivers and one or more base station transceivers, wherein the base station transceivers may establish macro cells or small cells, as e.g. pico-, metro-, or femto cells. A user equipment or mobile transceiver, e.g. the user equipment 200, may correspond to a smartphone, a cell phone, user equipment, a laptop, a note-book, a personal computer, a Personal Digital Assistant (PDA), a Universal Serial Bus (USB)-stick, a vehicle. A mobile transceiver may also be referred to as UE or mobile in line with the 3GPP terminology.

A base station transceiver, e.g. the base station transceiver 100, can be located in the fixed or stationary part of the network or system. A base station transceiver may correspond to a remote radio head, a transmission point, an access point or access node, a macro cell, a small cell, a micro cell, a femto cell, a metro cell. A base station transceiver can be a wireless interface of a wired network, which enables transmission of radio signals to a UE or mobile transceiver. Such a radio signal may comply with radio signals as, for example, standardized by 3GPP or, generally, in line with one or more of the above listed systems. Thus, a base station transceiver may correspond to a NodeB, an eNodeB, a gNodeB, a Base Transceiver Station (BTS), an access point, a remote radio head, a transmission point, which may be further di-vided into a remote unit and a central unit.

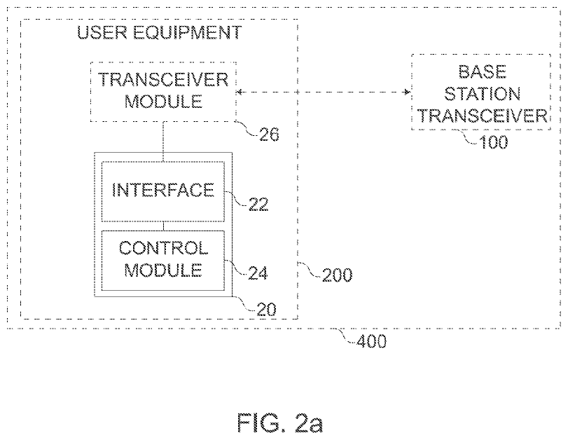

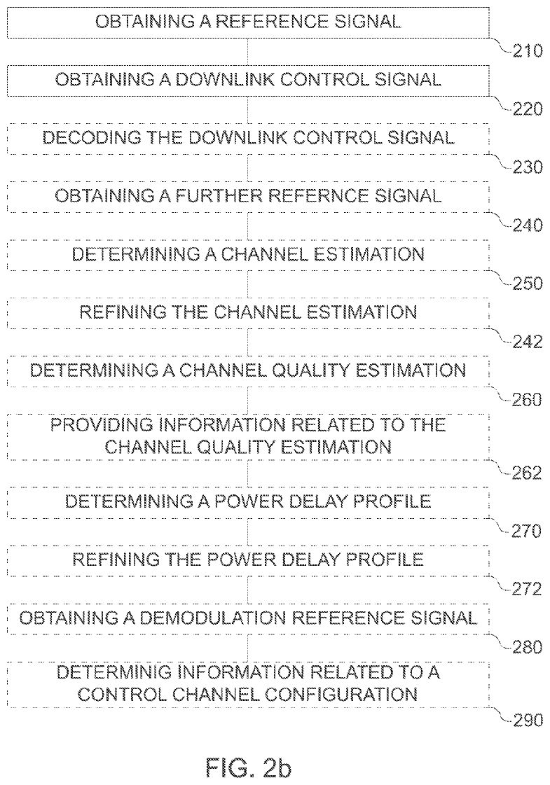

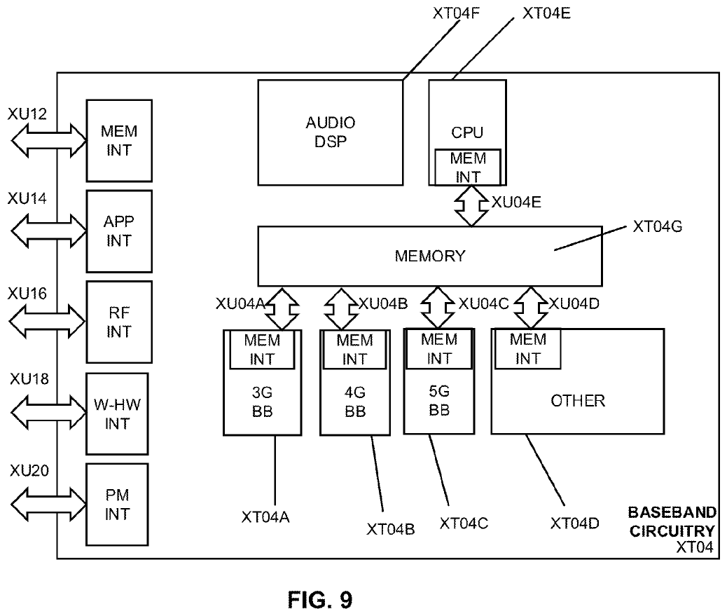

In examples the at least one interface 12, at least one interface 22 of a user equipment apparatus 20 introduced in connection with FIG. 2a, and/or at least one interface 32 of an apparatus 30 introduced in connection with FIG. 3a, may correspond to any means for obtaining, receiving, transmitting or providing analog or digital signals or information, e.g. any connector, contact, pin, register, input port, output port, conductor, lane, etc. which allows providing or obtaining a signal or information. Such information may be communicated in terms of analog or digital signals, e.g. by means of messages, digits or blocks represented by digital or binary sequences. An interface may be wireless or wireline and it may be configured to communicate, i.e. transmit or receive signals, information with further internal or external components. The at least one interface 12, 22; 32 may comprise or couple to further components to enable according communication in the mobile communication system or environment 400, such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc. The at least one interface 12, 22; 32 may be coupled to one or more antennas, e.g. via transceiver modules 16; 26; 36, which may correspond to any transmit and/or receive antennas, such as horn antennas, dipole antennas, patch antennas, sector antennas etc. The antennas may be arranged in a defined geometrical setting, such as a uniform array, a linear array, a circular array, a triangular array, a uniform field antenna, a field array, combinations thereof, etc. In some examples the at least one interface 12, 22 may serve the purpose of transmitting or receiving or both, transmitting and receiving, information, such as the reference signal, the downlink control signal, the control transmission, and/or the information related to a control channel configuration. In various examples, the at least one interface or means for processing 12; 22; 32 may be implemented by a radio frequency circuitry interface XU16 as shown in connection with FIG. 9.

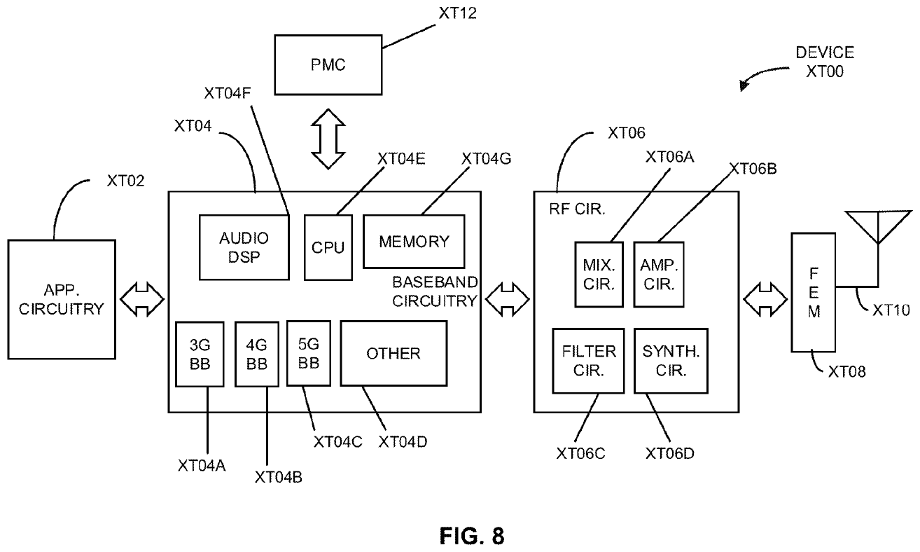

In examples the control module 14, a control module 24 of the user equipment apparatus 20 and/or a control module 34 of the apparatus 30 may be implemented using one or more processing units, one or more processing devices, one or more processing units, one or more processing or controlling devices, any means for processing/controlling, any means for determining, any means for calculating, such as a processor, a computer, a controller or a programmable hardware component being operable with accordingly adapted software. In other words, the described function of the control module 14; 24; 34 may as well be implemented in software, which is then executed on one or more programmable hardware components. Such hardware components may comprise a general-purpose processor, a controller, a Digital Signal Processor (DSP), a micro-controller, any hardware capable of executing software instructions. In examples accelerated hardware, e.g. an FPGA (Field Programmable Gate Array), may be used to implement the control module 14; 24; 34. In at least some examples, the control module 14; 24; 34 may be implemented by a by a central processing unit XT04E of a baseband circuitry XT04 as shown in FIGS. 8 and 9. In some embodiments, the control module 14; 24; 34 may be configured to use further processing circuitry, such as a third generation (3G) baseband processor XT04A, a fourth generation (4G) baseband processor XT04B, a fifth generation (5G) baseband processor XT04C, or other baseband processor(s) XT04D to perform its functionality.

The transceiver module 16, a transceiver module 26 of the user equipment 200, and/or a transceiver module 36 of the entity 300, may be implemented as any means for transceiving, i.e. receiving and/or transmitting etc., one or more transceiver units, one or more transceiver devices and it may comprise typical receiver and/or transmitter components, such as one or more elements of the group of one or more Low-Noise Amplifiers (LNAs), one or more Power Amplifiers (PAs), one or more filters or filter circuitry, one or more diplexers, one or more duplexers, one or more Analog-to-Digital converters (A/D), one or more Digital-to-Analog converters (D/A), one or more modulators or demodulators, one or more mixers, one or more antennas, etc. The transceiver module 16; 26; 36 may be implemented by a radio frequency circuitry XT06 as shown in connection with FIG. 8.

More details and aspects of the base station transceiver apparatus 100, the base station transceiver device 10 and/or the base station transceiver 100 are mentioned in connection with the proposed concept or one or more examples described above or below (e.g. FIG. 1b to 15). The base station transceiver apparatus 100, the base station transceiver device 10 and/or the base station transceiver 100 may comprise one or more additional optional features corresponding to one or more aspects of the proposed concept or one or more examples described above or below.

FIG. 1b shows a flow chart of a method (denoted “base station transceiver method”) for a base station transceiver 100 of/for a mobile communication system 400 according to at least some examples. The base station transceiver method comprises providing 110 a reference signal to a user equipment 200 of the mobile communication system 400. The reference signal is a reference signal for time tracking. The base station transceiver method comprises providing 120 a downlink control signal to the user equipment 200. The reference signal and the downlink control signal are quasi-co-located.

For example, the downlink control signal is provided via a physical downlink control channel, PDCCH, of the mobile communication system 400. For example, the downlink control signal and the reference signal may be transmitted based on the same spatial filtering parameters.

For example, the reference signal may be a tracking reference signal. Additionally or alternatively, the reference signal may be a beam-formed reference signal. Additionally or alternatively, the reference signal may be a user equipment-specific reference signal.

In at least some examples, the reference signal is an aperiodic reference signal. The base station transceiver method may comprise obtaining 130 information related a control transmission to be provided to the user equipment 200 using the downlink control signal. The aperiodic reference signal may be provided based on the information related to the control transmission to be provided to the user equipment 200. The base station transceiver method may comprise providing 132 the control transmission to the user equipment 200 using the downlink control signal after providing the aperiodic reference signal. In some examples, the base station transceiver method may comprise controlling 140 a number of repetitions of the aperiodic reference signal based on a time elapsed since a previous communication with the user equipment 200.

In various examples, the base station transceiver method may comprise obtaining 150 information related to a channel quality estimation of a channel between the base station transceiver 100 and the user equipment 200 from the user equipment 200. The base station transceiver method may comprise controlling 152 a bandwidth of the reference signal based on the information related to the channel quality estimation. For example, the base station transceiver method may comprise providing 110 the reference signal using a first larger bandwidth if a quality of the channel quality estimation is above a quality threshold and if a size of a control transmission to be provided using the downlink control signal is above a size threshold. The base station transceiver method may comprise providing 110 the reference signal using a second smaller bandwidth if a quality of the channel quality estimation is below the quality threshold or if the size of the control transmission to be provided using the downlink control signal is below the size threshold.

In at least some examples, the base station transceiver method comprises providing a further reference signal to the user equipment 200. The base station transceiver method may comprise providing a demodulation reference signal (DMRS) associated with the downlink control signal to the user equipment 200.

In some examples, the base station transceiver method may comprise obtaining 160 information related to a control channel configuration for a control channel of the downlink control signal. The information related to the control channel configuration may define one or more time-slots for the reference signal. The control channel configuration may define the reference signal and the downlink control signal to be quasi-co-located. The base station transceiver method may comprise providing 110 the reference signal based on the one or more time slots for the reference signal. In some examples, the base station transceiver method may comprise determining 162 the information related to the control channel configuration. The base station transceiver method may comprise providing the information related to the control channel configuration to the user equipment 200.

More details and aspects of the base station transceiver method are mentioned in connection with the proposed concept or one or more examples described above or below (e.g. FIG. 1a, 2a to 15). The base station transceiver method may comprise one or more additional optional features corresponding to one or more aspects of the proposed concept or one or more examples described above or below.

FIG. 2a shows a block diagram of an apparatus 20 or a device 20 (denoted “user equipment apparatus” or “user equipment device”) for a user equipment 200 of/for a mobile communication system 400 according to at least some examples. The components of the user equipment device 20 are defined as component means, which correspond to the respective structural components of the user equipment apparatus 20. FIG. 2a further shows the user equipment 200 comprising the apparatus 20. FIG. 2a further shows the mobile communication system 400 comprising a gNodeB 100 (e.g. the base station transceiver 100 introduced in connection with FIG. 1a) and the user equipment 200.

The user equipment apparatus 20 comprises at least one interface 22 (or a means for communicating 22 of the user equipment device 20) for communicating with a transceiver module 26 (or a means for transceiving 26) of the user equipment 200. The user equipment apparatus 20 comprises a control module 24 (or a means for controlling 24 of the user equipment device 20). The control module 24 is coupled to the at least one interface 22. The at least one interface 22 is coupled to the transceiver module 26. The control module 24 is configured to obtain a reference signal from a base station transceiver 100 of the mobile communication system 400 via the transceiver module 26 (e.g. to receive the reference signal via the transceiver module 26). The reference signal is a reference signal for time tracking. The control module 24 is configured to obtain a downlink control signal from the base station transceiver 100 via the transceiver module 26 (e.g. to receive the downlink control signal via the transceiver module 26). The reference signal and the downlink control signal are quasi-co-located. The user equipment apparatus 20 may be likewise a circuit, circuitry, a unit, a device, a chip, a semiconductor, or a printed circuit board with electrical components.

In this way, if the mobile communication system (e.g. the mobile communication system 400) decides to use a specific base station transceiver, e.g. a so-called hidden node, for transmitting control instructions to the user equipment 200, the (beam-formed) channel for transmitting the control instructions may be evaluated using the reference signal, which the user equipment 200 may use to decode the downlink control signal comprising the control instructions.

In at least some examples, the control module 24 is configured to decode the downlink control signal based on the obtained reference signal. This may use the quasi-co-located property of the reference signal and the downlink control signal. For example, the control module 24 may be configured to determine information related to a timing and/or frequency correction for a (downlink) control channel of the downlink control signal based on the reference signal. The control module 24 may be configured to decode the downlink control signal based on the information related to the timing and/or frequency correction for the control channel of the downlink control signal. By virtue of a detected reference signal (e.g. TRS), the UE may perform the timing/frequency correction for the subsequent control channel detection.

In at least some examples, the reference signal may be an aperiodic reference signal. The control module 24 may be configured to obtain (e.g. expect) and/or decode the downlink control signal (only) if it obtains the reference signal. The control module 24 may be configured to skip (e.g. refrain from) listening for (via the transceiver module 26), obtaining and/or (blind) decoding the downlink control signal if no reference signal is obtained. The control module 24 may be configured to switch to a power conservation setting if no reference signal is obtained. For example, the control module 24 is configured to obtain the downlink control signal via the transceiver module 26 at a first time interval (only) if the reference signal is obtained within a second time interval. The second time interval may lie before the first time interval. This may enable the user equipment 200 to only expect the downlink control signal, if the reference signal was detected in the second time interval. For example, the second time interval may be at a pre-defined time prior to the first time interval. For example, the second time interval may be a reference signal scheduling window. For example, the second time interval may be a pre-defined number of slots prior to the first time interval, e.g. prior to a control resource set provided on the (downlink) control channel. For example, the downlink control signal may be or comprise a paging control instruction. The control module 24 may be configured to skip a blind decoding of a paging occasion on the (downlink) control channel if no reference signal is received.

In at least some examples, the control module 24 may be configured to obtain a further reference signal from the base station transceiver 100 (e.g. via the transceiver module 26). For example, the further reference signal may be a Channel State Information Reference Signal (CSI-RS). Alternatively or additionally, the further reference signal may be or comprise a Synchronization Signal Block (SSB). The control module 24 may be configured to determine a channel estimation for a channel (e.g. the control channel) between the base station transceiver 100 and the user equipment 200 based on the further reference signal. For example, the channel estimation may comprise information related to a signal to noise ratio for a signal transmitted via channel between the base station transceiver 100 and the user equipment. The control module 24 may be configured to refine the channel estimation based on the reference signal. This may provide a channel estimation based on two reference signals, which may increase a precision and/or reliability of the channel estimation.

In at least some examples, the control module 24 may be configured to determine a channel quality estimation of the channel (e.g. the (downlink) control channel) between the base station transceiver 100 and the user equipment 200, e.g. based on the channel estimation and/or based on the further reference signal. The control module may be configured to provide information related to the channel quality estimation to the base station transceiver 100. For example, the information related to the channel quality estimation may comprise a channel quality indicator for the channel. A bandwidth of the reference signal may be based on the provided information related to the channel quality estimation. This may enable the base station transceiver to determine, at which modulation signals may be transmitted to the user equipment, and may thus enable the base station transceiver to choose the bandwidth for the reference signal accordingly, e.g. to choose a higher bandwidth, if a higher-complexity modulation is used, and to choose a lower bandwidth, if a lower-complexity modulation is used. In this way, the higher bandwidth might only be used, if the higher complexity of the modulation warrants the processing resources used for processing the reference signal having a higher bandwidth.

In at least some examples, the control module 24 may be configured to determine a power delay profile based on the reference signal. This may enable a determination of the power delay profile without additional reference signals being used. The control module 24 may be configured to determine the power delay profile based on one or more elements of the group of a signal-to-noise-ration of a received signal (e.g. the downlink control signal or the reference signal) in the current carrier bandwidth, a scheduled bandwidth (e.g. of the downlink control signal, e.g. in terms of resource blocks), a bandwidth of the reference signal and/or a modulation (e.g. a modulation and coding scheme, MCS) of scheduled data (e.g. of the downlink control signal). For example, the reference signal may be a periodic reference signal. The control module 24 may be configured to (continuously) refine the power delay profile continuously based on the periodic reference signal, e.g. the control module 24 may be configured to determine and/or refine the power delay profile based on a plurality of obtained instances of the periodic reference signal. This may increase a precision of the PDP estimation over time.

In some examples, the control module 24 may be configured to obtain a demodulation reference signal associated with the downlink control signal via the transceiver module 26. For example, the downlink control signal may comprise the demodulation reference signal associated with the downlink control signal. The control module 24 may be configured to determine the power delay profile based on the reference signal and based on the demodulation reference signal. This may enable increasing a precision of the PDP estimation. For example, the demodulation reference signal may be associated with a control transmission via the downlink control signal. The control module 24 may be configured to determine the power delay profile based on the reference signal and based on the demodulation reference signal (only) if a size of the control transmission is larger than a size threshold. The control module 24 may be configured to determine the power delay profile without using the demodulation reference signal if the size of the control transmission is lower than size threshold. The control module 24 may be configured to determine the power delay profile based on the reference signal and based on the demodulation reference signal (only) if a modulation complexity of the downlink control signal is above a modulation complexity threshold. The control module 24 may be configured to determine the power delay profile without using the demodulation reference signal if the modulation complexity of the downlink control signal is below the modulation complexity threshold. This may avoid using processing resources for the determination of the PDP if the size of the control transmission is lower than the size threshold or if a complexity of the modulation is below a modulation complexity threshold. This may conserve energy in small and/or low complexity downlink control signal transmissions.

In various examples, the control module 24 is configured to obtain information related to a control channel configuration for a control channel of the downlink control signal. The information related to the control channel configuration may define one or more time-slots for the reference signal. The control channel configuration defines the reference signal and the downlink control signal to be quasi-co-located. The control module 24 may be configured to obtain the reference signal based on the one or more time slots for the reference signal. This may enable the user equipment to expect, and thus wake up for, the reference signal (only) at the one or more time slots. For example, the control module 24 may be configured to expect and/or (blind) decode the reference signal based on the one or more time slots for the reference signal.

More details and aspects of the user equipment apparatus 20, user equipment device 20 or user equipment 200 are mentioned in connection with the proposed concept or one or more examples described above or below (e.g. FIG. 1a to 1b, 2b to 15). The user equipment apparatus 20, user equipment device 20 or user equipment 200 may comprise one or more additional optional features corresponding to one or more aspects of the proposed concept or one or more examples described above or below.

FIG. 2b shows a flow chart of a method (denoted “user equipment method”) for a user equipment 200 of/for a mobile communication system 400 according to at least some examples. The user equipment method comprises obtaining 210 a reference signal from a base station transceiver 100 of the mobile communication system 400. The reference signal is a reference signal for time tracking. The user equipment method comprise obtaining 220 a downlink control signal from the base station transceiver 100. The reference signal and the downlink control signal are quasi-co-located. In at least some examples, the user equipment method comprises decoding 230 the downlink control signal based on the obtained reference signal.

In at least some examples, the user equipment method comprises obtaining 220 the downlink control signal at a first time interval (only) if the reference signal is obtained within a second time interval. The second time interval may lie before the first time interval.

In some examples, the user equipment method comprises obtaining 240 a further reference signal from the base station transceiver 100. The user equipment method may comprise determining 250 a channel estimation for a channel between the base station transceiver 100 and the user equipment 200 based on the further reference signal. The user equipment method may comprise refining 242 the channel estimation based on the reference signal.

In various examples, the user equipment method comprises determining 260 a channel quality estimation of a channel between the base station transceiver 100 and the user equipment 200. The user equipment method may comprise providing 262 information related to the channel quality estimation to the base station transceiver 100. A bandwidth of the reference signal may be based on the provided information related to the channel quality estimation.

The user equipment method may comprise determining 270 a power delay profile based on the reference signal. For example, the reference signal is a periodic reference signal. The user equipment method may comprise refining 272 the power delay profile continuously based on the periodic reference signal. The user equipment method may comprise obtaining 280 a demodulation reference signal associated with the downlink control signal. The user equipment method may comprise determining 270 the power delay profile based on the reference signal and based on the demodulation reference signal. For example, the demodulation reference signal may be associated with a control transmission via the downlink control signal. The user equipment method may comprise determining 270 the power delay profile based on the reference signal and based on the demodulation reference signal (only) if a size of the control transmission is larger than a size threshold.

In various examples, the user equipment method comprises obtaining 290 information related to a control channel configuration for a control channel of the downlink control signal, e.g. from the base station transceiver 100 or from an entity 300 of the mobile communication system 400. The information related to the control channel configuration may define one or more time-slots for the reference signal. The control channel configuration may define the reference signal and the downlink control signal to be quasi-co-located. The user equipment method may comprise obtaining 210 the reference signal based on the one or more time slots for the reference signal.

More details and aspects of the user equipment method are mentioned in connection with the proposed concept or one or more examples described above or below (e.g. FIG. 1a to 2a, 3a to 15). The user equipment method may comprise one or more additional optional features corresponding to one or more aspects of the proposed concept or one or more examples described above or below.

FIG. 3a shows a block diagram of an apparatus 30 or device 30 for an entity 300 of/for a mobile communication system 400 according to at least some examples. The components of the device 30 are defined as component means, which correspond to the respective structural components of the apparatus 10. FIG. 3a further shows the entity 300 of the mobile communication system 400 comprising the apparatus 30. FIG. 3a further shows the mobile communication system 400 comprise a gNodeB 100 (e.g. the base station transceiver 100 introduced in connection with FIG. 1a), a user equipment 200 (e.g. the user equipment 200 introduced in connection with FIGS. 1a and 2a), and the entity 300.

The apparatus 30 comprises at least one interface 32 (or a means for communicating 32 of the device 30) for communicating with a transceiver module 36 (or a means for transceiving 36) of the entity 300. The apparatus 30 comprise a control module 34 (or a means for controlling 34 of the device 30). The control module 34 is coupled to the at least one interface 32. The at least one interface 32 is coupled with the transceiver module 36. The control module 34 is configured to determine information related to a control channel configuration. The control channel configuration is suitable for a control channel for a downlink control signal. The information related to the control channel configuration defines one or more time-slots for a reference signal for time tracking. For example, the reference signal may be an aperiodic reference signal. The control channel configuration defines the reference signal and the downlink control signal to be quasi-co-located. The control module 34 is configured to provide the information related to the control channel configuration to the base station transceiver 100 and to the user equipment 200. The apparatus 30 may be likewise a circuit, circuitry, a unit, a device, a chip, a semiconductor, or a printed circuit board with electrical components.

For example, the entity 300 may be a base station transceiver of the mobile communication system 400. For example, the entity 300 and the base station transceiver 100 may both be separate base stations of the mobile communication system. Alternatively, the base station transceiver 100 may be a remote radio head of the entity 300. In at least some examples, the entity 300 may be an entity 300 of the mobile communication system capable of providing a control channel configuration for a control channel for a downlink control signal.

The properties of the control channel may be defined by a control channel configuration. For example, the control channel configuration may comprise information related to the reference signal. The information related to the control channel configuration may define one or more time-slots for the reference signal (e.g. one or more time-slots before providing the downlink control signal and/or one or more time-slots before a provision of a control resource set for the control channel). The control channel configuration may define the reference signal and the downlink control signal to be quasi-co-located. The control channel configuration may define it to be mandatory that the reference signal and the downlink control signal are quasi-co-located. The control module 34 may be configured to provide the reference signal based on the one or more time slots for the reference signal. If the reference signal is an aperiodic reference signal, the control module 34 may be configured to choose one or a subset of the one or more time slots may be chosen for the reference signal.

The control channel configuration may comprise information related to a time-frequency resource allocation for the reference signal, information related to a reference signal scheduling window and information related to a sequence of the reference signal. The information related to the time-frequency resource allocation for the reference signal may comprise a time duration of the reference signal (e.g. defined in terms of number of slots), a reference signal symbols index within the slot (e.g. in which one or more symbols within a slot may the reference signal be provided), a set of allocated resource blocks for the reference signal, and a set of subcarriers of the reference signal (e.g. the periodicity of the reference signal in a comb structure). The information related to a reference signal scheduling window may comprise information related to a pre-defined number of slots in which the reference signal is allowed to be provided prior to a provision of a control resource set of the control channel. For example, the reference signal may be provided in one or more of the pre-defined number of slots prior to the provision of the control resource set for the control channel. In at least some examples, the pre-defined number of slots may be 1. For example, the reference signal might be allowed to be provided in the slot preceding the provision of the control resource set for the control channel. The information related to the sequence of the reference signal may comprise scrambling identifier of the reference signal sequence.

The control module 34 is be configured to provide the information related to the control channel configuration to the user equipment 200 and to the base station transceiver 100. This may enable the entity to set the control channel configuration for the cell(s) of the mobile communication system associated with the base station transceiver 100. For example, the control module 34 may be configured to provide the information related to the control channel configuration to the user equipment 200 and to the base station transceiver 100 using a radio resource control (RRC) protocol.

More details and aspects of the apparatus 30, device 30 or entity 300 are mentioned in convection with the proposed concept or one or more examples described above or below (e.g. FIG. 1a to 2b, 3b to 15). The apparatus 30, device 30 or entity 300 may comprise one or more additional optional features corresponding to one or more aspects of the proposed concept or one or more examples described above or below.

FIG. 3b shows a flow chart of a method for an entity 300 of/for a mobile communication system 400 according to at least some examples. The mobile communication system 400 further comprises a base station transceiver 100 and a user equipment 200. The method comprises determining 310 information related to a control channel configuration. The control channel configuration is suitable for a control channel for a downlink control signal. The information related to the control channel configuration defines one or more time-slots for a reference signal for time tracking. The control channel configuration defines the reference signal and the downlink control signal to be quasi-co-located. The method comprises providing 320 the information related to the control channel configuration to the base station transceiver 100 and to the user equipment 200. In at least some examples, the reference signal is an aperiodic reference signal.

More details and aspects of the method are mentioned in connection with the proposed concept or one or more examples described above or below (e.g. FIG. 1a to 3a, 4 to 15). The method may comprise one or more additional optional features corresponding to one or more aspects of the proposed concept or one or more examples described above or below.

At least some examples may provide a TRS assisted control channel transmission and reception (e.g. at a Radio Access Network of a 5G mobile communication system).

In 3GPP 5G new radio (NR) system, due to variety of different envisioned deployment scenarios, the baseline receiver scheme reusing the principle from an LTE system may suffer from severe performance loss. For example, due to potential timing/frequency synchronization errors, the transmission of SFN (Single Frequency Network) based NR-SIB1/paging (New Radio-System Information Block 1), or hidden node based RACH (Random Access Channel) response (RAR) channels may considerably deteriorate the respective UE baseline receiver, in which cell/beam-specific synchronization signal block (SSB) may be used as the timing/frequency reference for reception of these physical channels. For the channel experienced by SFN-based NB-SIB1/Paging might be quite different from that of SSBs with beam sweeping, and the hidden node for RAR transmission might not transmit the SSB at all. As a result, in these cases, SSBs might not be able to provide sufficiently accurate timing/frequency synchronization to achieve desired reception performance of respective control and data channels.

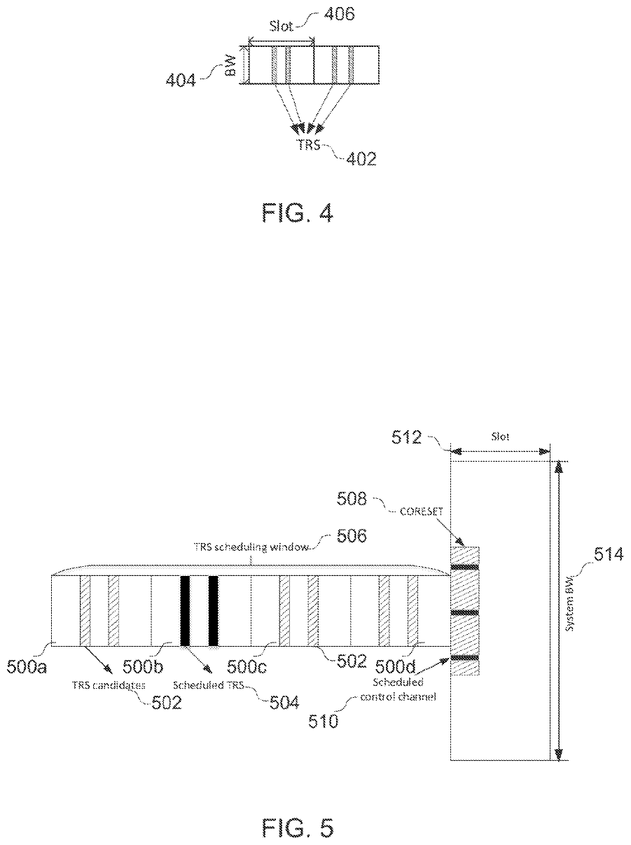

To mitigate the above issues among others, a tracking reference signal (TRS) may be adopted to help the UE to track timing and frequency offset when necessary. FIG. 4 shows a schematic diagram of a tracking reference signal. Specifically, as shown in FIG. 4, TRS may be configured as UE-specific periodic signal with confined time-frequency resources 402, e.g. several (up to 4) OFDM symbols within one or two consecutive slots 406 in time and around 24 or 50 RBs (Resource Blocks) in frequency (bandwidth, BW) 404. FIG. 4 may show a tracking reference signal transmission.

Various embodiments herein provide aperiodic TRS transmission mechanisms to tackle the timing/frequency synchronization problem in a more flexible manner from network resource scheduling point of view. For example, the TRS may be the reference signal introduced in connection with FIGS. 1a to 3b. The aperiodic TRS transmission might (only) be scheduled at a time interval preferred by network as well as UE (e.g. according to the information related to a control channel configuration). Moreover, the concrete TRS scheduling methods used for PDCCH (Physical Downlink Control Channel) transmission for SFN based paging and hidden node based RAR might also be shown in examples. As a result, a method of aperiodic TRS assisted self-contained control channel transmission is provided by at least some examples.

If a periodic TRS is used as reference signal, the periodic TRS may be transmitted all the time before it is released by re-configuration. This may lead to some unnecessary energy consumption. Moreover, the periodic TRS may use a complex method to resolve the possible colliding of pre-booked regular resources and instantaneous transmission demands of some urgent traffic like URLLC (Ultra Reliable Low Latency Communication).

At least some examples are based on an aperiodic TRS transmission. Specifically, in a self-contained control search space configuration, a TRS transmission window duration in terms of slot may be configured as well (e.g. using the information related to a control channel configuration). It may be up to a gNB (e.g. the base station transceiver apparatus/device 10) to determine which slots in the configured time window may be used for a particular TRS transmission (e.g. the reference signal) before the associated control channel transmission. Prior to detection of the control channel, a UE (e.g. the user equipment 200) may first search the TRS in the configured time window. By virtue of a detected TRS (e.g. in the second time interval as introduced in connection with FIG. 2a), the UE may perform the timing/frequency correction for the subsequent control channel detection (in the first time interval).

At least some examples may enable TRS to be scheduled in more flexible manner based on actual transmission need. With a configured time window, the gNB can flexibly choose which particular slots (e.g. of the one or more slots) in the time window to be used for TRS in case of resource colliding, e.g., with URLLC traffic. If there is no control channel transmission, the corresponding TRS might not be transmitted so as to save network energy.

FIG. 5 shows a self-contained control channel with quasi-co-located TRS configuration with a TRS scheduling window 506 comprising 4 slots 500a to 500d. The slots comprise TRS candidates 502. In one of the TRS candidates, the scheduled TRS 504 is comprised in the TRS scheduling window. FIG. 5 508 shows the Control Resource Set (CORESET) 508 and the scheduled control channel 510. FIG. 5 further shows a location of the Control Resource Set 508 within a Slot 512 and a System Bandwidth 514.

In an example, ab aperiodic QCLed (Quasi-co-located) TRS based self-contained PDCCH configuration may be used. The self-contained control channel configuration is illustrated in FIG. 5. In addition to the control resource set (CORESET), the control channel search space may also be configured with a quasi-co-located (or quasi-colocated) (QCLed) TRS (e.g. the reference signal). The TRS may be quasi-co-located with downlink control transmission on the PDCCH. The QCLed TRS configuration (e.g. the information related to a control channel configuration) may include/comprise one or more of the following information:
TRS time-frequency resource allocation
   TRS time duration in terms of number of slots
   TRS symbols index within the slot
   Set of allocated RBs for TRS
   Set of subcarriers of TRS, e.g., the periodicity of subcarrier spacing in a comb structure.
TRS scheduling window
   This may be defined by the number of slots preceding to the CORESET, where the QCLed TRS can be scheduled.
TRS sequence
   Scrambling ID of the TRS sequence

The above TRS resource among other physical layer resources may at least partially be configured to UE by RRC (Radio Resource Control) signaling. For example, the control channel configuration may be obtained or provided using RRC. In the PDCCH SS (Synchronization Signal) configuration, the QCLed RS (Reference Signal) parameter may link to the index of the configured aperiodic TRS.

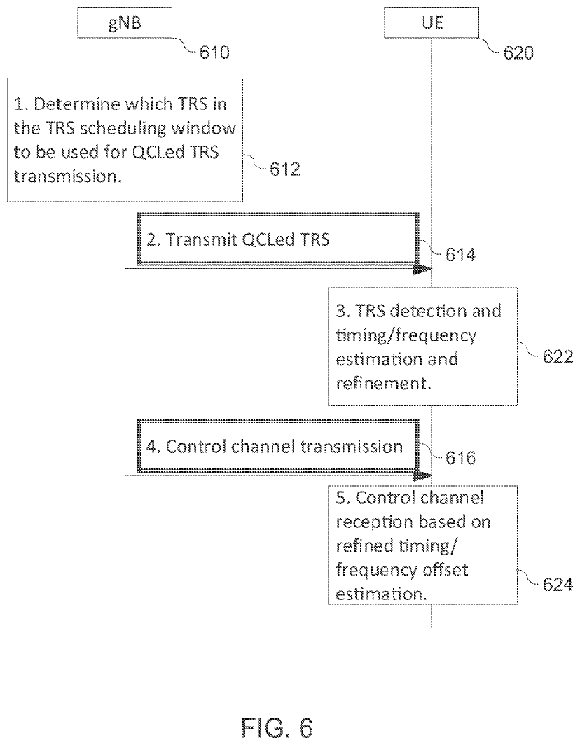

For the transmission of each control channel with QCLed TRS, the gNB (e.g. the base station transceiver apparatus/device 10) may first determine which slots in the TRS scheduling window may be used for the actual TRS transmission. Based on this decision, the QCLed TRS may be transmitted before the associated control channel transmission (e.g. the downlink control signal). As shown in FIG. 5, the TRS scheduling window consists of 4 slots 500a-500d, and each TRS instance 502 is comprised of 2 symbol in one slot. As such, 4 possible TRS transmission candidates are configured in the TRS scheduling window 506. In the example of FIG. 5, the 2nd TRS candidate 504 is transmitted to assist the timing/frequency tracking for the reception of the corresponding control channel in green. At the receive side, the UE (e.g. the user equipment 200) may first search the TRS 504 within the TRS scheduling window 506, based on the detected TRS, refined timing/frequency error estimate may be obtained, and can be further used for the reception of scheduled control channel (e.g. of the downlink control signal). An example of such a procedure may be depicted in FIG. 6.

FIG. 6 shows a flow chart of a self-contained control channel transmission. In FIG. 6, the gNB 610 (e.g. the base station transceiver 100 and/or the base station transceiver apparatus/device 10) may determine 612 which TRS in the TRS scheduling window is to be used for the quasi-co-located TRS transmission (e.g. the reference signal). Based on the determination 612, the QCLed TRS may be transmitted 614 by the gNB 610 to the user equipment 620 (e.g. the user equipment 200). The user equipment 620 may perform 622 TRS detection and timing/frequency estimation and refinement. The gNB 610 may then transmit 616 the control channel transmission (e.g. the downlink control signal) to the UE 620. At the UE 620, the control channel may be received 624 based on the refined timing/frequency offset estimation.

In some examples, the TRS scheduling window duration may be equal to that of one TRS transmission instance. This may result in the special case that TRS monitoring window is 1 TRS transmission time interval. In this case, with less TRS scheduling flexibility at network, the TRS search complexity at the UE may be reduced. Therefore, this may enable a trade-off between network scheduling flexibility and UE TRS search/detection complexity.

At least some examples may further provide aperiodic TRS assisted SFN-based paging PDCCH transmission and reception.

In NR, paging indication may be delivered by PDCCH scheduled PDSCH (Physical Downlink Shared Channel). Thanks to an SFN (Single Frequency Network) gain up to 4.3 dB, SFN-based paging transmissions may be preferred to obtain better paging coverage and save the radio resource overhead especially compared to the beam formed paging transmission in high frequency band, where paging may be transmitted in all cells belonging to the tracking area of the UE in idle mode.

To realize SFN-based paging PDCCH transmission, the gNB can configure the search space of paging PDCCH by using above examples. Specifically, the configured QCLed TRS may be transmitted in SFN manner, i.e., the TRS may be transmitted from all the gNBs and/or low power nodes in the tracking area of the UE. The scrambling ID of the TRS can be viewed as the ID of the large SFN cell. Compared to other periodic reference signal, a QCLed aperiodic TRS configuration may save the energy for both network and UEs. From a network side, aperiodic QCLed TRS might be transmitted only when paging PDCCH is scheduled, i.e., no TRS might be transmitted for an empty paging occasion. This might not be the case for “always-on” periodic TRS transmission. This may enable the on-off transmission of the large SFN cell. For the UE, prior to each paging occasion, if the UE fails to detect QCLed TRS, UE can simply skip the subsequent paging PDCCH blind decoding. In this case, the TRS (e.g. in the second time interval) may serve as a “beacon” signal indicating the presence of any paging PDCCH transmission in the following paging occasion (e.g. in the first time interval).

At least some examples may further provide aperiodic TRS assisted hidden node based RAR PDCCH transmission and reception.

When a NR UE (e.g. the user equipment 200) conducts random access (RACH) procedure in high frequency, i.e., by transmitting PRACH (Physical Random Access Channel) preamble in high frequency, it is possible that multiple network nodes including those so called “hidden nodes” not sending any synchronization signals, can receive the PRACH preamble from the UE. When the network (e.g. the mobile communication system 400) decides to send RAR (e.g. the downlink control signal) to the UE by the hidden node (e.g. the base station transceiver 100), due to the absence of sync signal from the hidden node, the UE (e.g. the user equipment 200) may have unacceptable timing/frequency errors with respect to the hidden nodes so that RAR might not be correctly received by the UE. To tackle this issue, the QCLed TRS might also be configured to the search space for RAR PDCCH by using the method according to examples.

For each possible RAR PDCCH transmission within the RAR reception window, the UE may first try to detect the QCLed TRS within the configured TRS window associated with the RAR PDCCH SS (e.g. within the second time interval). Based on the detection results of QCLed TRS, UE can further apply the timing/frequency offset correction for the subsequent RAR PDCCH reception (e.g. in the first time interval), or simply skip the RAR PDCCH blind decoding otherwise. Similar to above methods, such TRS detection induced RAR PDCCH reception may also reduce the UE energy consumption during the RACH procedure.

At least some examples relate to an aperiodic QCLed TRS based self-contained PDCCH configuration.

Example A1 may include a method comprising: configuring or causing to configure the self-contained control channel configuration with a quasi-colocated (QCLed) aperiodic TRS.

Example A2 may include the method of example A1 and/or some other examples herein, wherein the QCLed TRS configuration includes the following information:
TRS time-frequency resource allocation
   TRS time duration in terms of number of slot
   TRS symbols index within the slot
   Set of allocated RBs for TRS
   Set of subcarriers of TRS, e.g., the periodicity of subcarrier spacing in a comb structure.
TRS scheduling window
   This can be defined by the number of slots preceding to the CORESET, where the QCLed TRS can be scheduled.
TRS sequence
   Scrambling ID of the TRS sequence

Example A3 may include the method of examples A1-A2 and/or some other examples herein, wherein the TRS scheduling window duration can be equal to one TRS transmission time interval.

Example A4 may include the method of examples A1-A3 and/or some other examples herein, wherein the above TRS resource among other physical layer resources can be at least partially configured to UE by RRC signaling, and in the PDCCH SS configuration, the QCLed RS parameter links to the index of the configured aperiodic TRS.

Example A5 may include a method of transmission of each control channel with QCLed TRS, wherein a gNB shall first determine which slots in the TRS scheduling window shall be used for the actual TRS transmission, and the QCLed TRS will be transmitted before the associated control channel transmission. Example 5 may be combined with any one or more of examples A1-A4 and/or some other examples herein.

Example A6 may include the method of example A5 and/or some other examples herein, wherein, at the receive side, a UE shall first search the TRS within the TRS scheduling window, based on the detected TRS, refined timing/frequency error estimate shall be obtained, and can be further used for the reception of scheduled control channel.

Example A7 may include a method of delivering an NR paging indication by SFN-based PDCCH scheduled PDSCH, and a gNB can configure the search space of paging PDCCH by using the above method of examples A1-A4.

Example A8 may include the method of example A7 and/or some other examples herein, wherein the configured QCLed TRS shall be transmitted in SFN manner, e.g., the TRS shall be transmitted from all the gNBs and/or low power nodes in the tracking area of the UE.

Example A9 may include the method of examples A7-A8 and/or some other examples herein, wherein the scrambling ID of the TRS can be viewed as the ID of the large SFN cell.

Example A10 may include the method of examples A7-A9 and/or some other examples herein, wherein the aperiodic QCLed TRS is transmitted only when paging PDCCH is scheduled, e.g., no TRS is transmitted for an empty paging occasion, wherein this effectively realizes the on-off transmission of the large SFN cell.

Example A11 may include the method of examples A7-A10 and/or some other examples herein, wherein, for the UE, prior to each paging occasion, if UE fails to detect QCLed TRS, UE can simply skip the subsequent paging PDCCH blind decoding.

Example A12 may include a method comprising: receiving or causing to receive, when multiple network nodes including those so called “hidden nodes” not sending any synchronization signals, a PRACH preamble from a UE, wherein the network can decide to send RAR to the UE by the hidden node.

Example A13 may include the method of example 12 and/or some other examples herein, wherein the QCLed aperiodic TRS can be configured to the search space for RAR PDCCH by using the above method examples A1-A4.

Example A14 may include the method of examples A12-A13 and/or some other examples herein, wherein, for each possible RAR PDCCH transmission within the RAR reception window, UE first tries to detect the QCLed TRS within the configured TRS window associated with the RAR PDCCH SS.

Example A15 may include the method of examples A12-A14 and/or some other examples herein, wherein, based on the detection results of QCLed TRS, UE can further apply the timing/frequency offset correction for the subsequent RAR PDCCH reception, or simply skip the RAR PDCCH blind decoding otherwise.

Example A16 may include an apparatus comprising means to perform one or more elements of a method described in or related to any of examples A1-A15, or any other method or process described herein.

Example A17 may include one or more non-transitory computer-readable media comprising instructions to cause an electronic device, upon execution of the instructions by one or more processors of the electronic device, to perform one or more elements of a method described in or related to any of examples A1-A15, or any other method or process described herein.

Example A18 may include an apparatus comprising logic, modules, or circuitry to perform one or more elements of a method described in or related to any of examples A1-A15, or any other method or process described herein.

Example A19 may include a method, technique, or process as described in or related to any of examples A1-A15, or portions or parts thereof.

Example A20 may include an apparatus comprising: one or more processors and one or more computer readable media comprising instructions that, when executed by the one or more processors, cause the one or more processors to perform the method, techniques, or process as described in or related to any of examples A1-A15, or portions thereof.

Example A21 may include a signal as described in or related to any of examples A1-A15, or portions or parts thereof.

Example A22 may include a signal in a wireless network as shown and described herein.

Example A23 may include a method of communicating in a wireless network as shown and described herein.

Example A24 may include a system for providing wireless communication as shown and described herein.

Example A25 may include a device for providing wireless communication as shown and described herein.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

More details and aspects of the method are mentioned in connection with the proposed concept or one or more examples described above or below (e.g. FIG. 1a to 3b, 7 to 15). The method may comprise one or more additional optional features corresponding to one or more aspects of the proposed concept or one or more examples described above or below.

Examples further provide methods for energy efficient channel power delay profile estimation (e.g. in a 5G Radio Access Network).

In 3GPP new radio (NR) system, tracking reference signal (TRS) has been agreed to aid the large scale channel parameter estimation, e.g., time and frequency offset, channel power delay profile (PDP) etc. Specifically, the PDP estimation may be used for filter design for the channel estimates obtained from demodulation reference signals (DMRS). In principle, PDP may be estimated from different reference signals including both TRS and DMRS. However, the estimation accuracy and complexity may be different when different RSes (Reference Signals) are employed. For instance, the TRS may be transmitted with different bandwidths, e.g. two options, i.e., ˜24 resource blocks (RB) and ˜50 RBs, may be comprised in the NR standard. The larger bandwidth the TRS, the more accurate PDP estimate may be achieved. In other words, the more accurate PDP estimation may be achieved at the cost of larger computation complexity with more energy consumption including both computation power consumption and transmission RS energy. PDP might also be estimated from DMRS. In case of scheduling a large data bandwidth, the corresponding DMRS may also have a large bandwidth as well. Therefore, a PDP estimation obtained from DMRS of large bandwidth may achieve a better accuracy. However, the computation burden of DMRS based PDP estimation might be even more demanding due to stricter timing specification.

In addition to the above trade-off between PDP estimation complexity and accuracy, the data throughput performance might also depend on other factors which may have more prominent effects, e.g., scheduled bandwidth and signal to noise ratio (SNR) experienced at the receiver (e.g. the user equipment 200). As such, to have an energy efficient receiver to achieve best possible link performance, all these factors may be taken into account.

At least some examples may provide an energy efficient PDP estimation method to achieve desired estimation accuracy at the smallest possible complexity and energy consumption for different data scheduling bandwidths and SNR operation points.

In the method according to examples, the PDP estimation may be performed by using the configured TRS for the normal data scheduling. The bandwidth of the configured TRS (e.g. the bandwidth of the reference signal) may be determined based on the estimation of UE data bandwidth allocation as well as the CQI (e.g. the channel quality estimation) feedback from the UE. When a data packet of large bandwidth using the MCS (Modulation Coding Scheme) corresponding to the highest CQI value is scheduled, the enhanced PDP estimation based on joint TRS and DMRS (Demodulation Reference signal) may be performed and used for the channel estimation (e.g. to determine the PDP) so that maximum nominal throughput may be achieved.

At least some examples may provide an energy efficient PDP estimation method, so that joint TRS and DMRS based PDP estimation might only be performed for the case where PDP estimation accuracy has critical impact on the expected throughput. The TRS bandwidth may be selected based on the data allocation bandwidth and CQI value so that energy efficient TRS transmission might also be achieved.

The PDP estimation method of at least some examples may take into the following factors:
SNR of the received signal in the current carrier bandwidth.
Scheduled bandwidth in terms of resource blocks.
The bandwidth of configured TRS
Modulation code scheme (MCS) of scheduled data

The following measures may be used in the PDP estimation method according to at least some examples.

Measure 1: UE SNR Estimation and CQI Feedback

The UE may perform the SNR estimation (e.g. the channel estimation) based on the synchronization signal block (SSB) and/or CSI-RS (Channel State Information-Reference Signals). Based on the SNR estimate, UE calculates the channel quality indicator (CQI) (e.g. the channel quality estimation), and sends the CQI feedback (e.g. the information related to the channel quality estimation) to the network so that network can determine proper modulation coding scheme (MCS) for the data to be scheduled for the UE.

Measure 2: TRS Configuration to the UE

The network may configure a TRS (e.g. the reference signal) with a certain bandwidth to the UE. The bandwidth of the TRS might either be ˜24 RBs or ˜50 RBs. The TRS bandwidth selection may be based on the data bandwidth estimation. For example, with the statistics on the DL (Downlink) MAC (Medium Access Control) buffer status of the UE and reported CQI value, the network (e.g. the base station transceiver 100) may estimate whether a large or small bandwidth would be used for the UE. In case of small data bandwidth allocation, the TRS of ˜24 RBs may be configured to the UE (e.g. by controlling the bandwidth of the reference signal), otherwise TRS of ˜50 RBs may be configured.

Measure 3: TRS Based Long Term PDP Estimation

In this measure, the UE may perform the long term PDP estimation, Pdp_TRS, based on the configured TRS in measure 2. If the TRS is transmitted periodically, the long term PDP estimate Pdp_TRS (e.g. the channel estimation and/or the power delay profile) may be continuously refined in order to track the variation of PDP estimation.

Measure 4: (Optional) DMRS Based PDP Estimation.

When a DL data is scheduled by the physical downlink control channel (PDCCH), the DMRS associated with scheduled data may be used for raw channel estimation, chanEst_raw. In case of large data bandwidth being scheduled with the MCS corresponding to the best CQI value, chanEst_raw may be used to perform the PDP estimation (e.g. of the channel estimation and/or the power delay profile) so that DMRS based PDP estimation Pdp_DMRS can be obtained. Then an enhanced PDP estimation Pdp_est can be calculated based on both Pdp_TRS and Pdp_DMRS.

Measure 5: Enhanced DMRS Based Channel Estimation for Data Demodulation.

The MMSE (Minimum Mean Square Error) based channel estimation filter might typically be used to filter the raw channel estimates chanEst_raw obtained from DMRS to generate more accurate channel estimates (e.g. the channel estimation and/or the power delay profile). The MMSE channel estimation filter may be calculated by virtue of PDP estimate. If the joint TRS and DMRS based PDP estimation, Pdp_est is available, it may be used for MMSE filter calculation. Otherwise TRS based PDP estimate, Pdp_TRS, may be used to obtain the MMSE filter.

Some examples and example combination are introduced in the following.

In example B1, the PDP estimation method may take into account at least a subset of the following factors: SNR of the received signal in the current carrier bandwidth, Scheduled bandwidth in terms of resource blocks, the bandwidth of the configured TRS, and a modulation code scheme (MCS) of scheduled data.

Measure 1: UE SNR Estimation and CQI Feedback

In example B2, the subject matter of any of the Examples described herein may further include that the UE may perform the SNR estimation based on synchronization signal block (SSB) and/or CSI-RS. Based on the SNR estimate, the UE may calculate the channel quality indicator (CQI), and send the CQI feedback to the network so that network can determine proper modulation coding scheme (MCS) for the data to be scheduled for the UE.

Measure 2: TRS Configuration to the UE

In example B3, the subject matter of any of the Examples described herein may further include that the network may configure a TRS with a certain bandwidth to the UE. The bandwidth of the TRS might be either ˜24 RBs or ˜50 RBs. The TRS bandwidth selection may be based on the data bandwidth estimation.

In example B4, the subject matter of any of the Examples described herein may further include that with the statistics on the DL MAC buffer status of the UE and reported CQI value, the network may estimate whether a large or small bandwidth would be used for the UE.

In example B5, the subject matter of any of the Examples described herein may further include that in case of small data bandwidth allocation, the TRS of ˜24 RBs may be configured to the UE, otherwise TRS of ˜50 RBs may be configured.

Measure 3: TRS based long term PDP estimation

In example B6, the subject matter of any of the Examples described herein may further include that the UE may perform the long term PDP estimation, Pdp_TRS, based on the configured TRS in examples B3-B5. The long term PDP estimate Pdp_TRS may be continuously refined in order to track the variation of PDP estimation.

Measure 4: (Optional) DMRS Based PDP Estimation.

In example B7 the subject matter of any of the Examples described herein may further include that when a DL data is scheduled by the physical downlink control channel (PDCCH), the DMRS associated with scheduled data may be used for raw channel estimation, chanEst_raw.

In example B8, the subject matter of any of the Examples described herein may further include that in case of large data bandwidth being scheduled with the MCS corresponding to the best CQI value, chanEst_raw may be used to perform the PDP estimation so that DMRS based PDP estimation Pdp_DMRS may be obtained.

In example B9, the subject matter of any of the Examples described herein may further include that enhanced PDP estimation Pdp_est (e.g. the power delay profile) may be calculated based on both Pdp_TRS and Pdp_DMRS.

Measure 5: Enhanced DMRS Based Channel Estimation for Data Demodulation.

In example B10, the subject matter of any of the Examples described herein may further include that the MMSE based channel estimation filter may be used to filter the raw channel estimates chanEst_raw obtained from DMRS to generate more accurate channel estimates.

In example B11, the subject matter of any of the Examples described herein may further in-dude that the MMSE channel estimation filter may be calculated by virtue of PDP estimate.

In example B12, the subject matter of any of the Examples described herein may further include that if the joint TRS and DMRS based PDP estimation, Pdp_est is available, it may be used for MMSE filter calculation. Otherwise TRS based PDP estimate, Pdp_TRS, may be used to obtain the MMSE filter.

More details and aspects of the method are mentioned in connection with the proposed concept or one or more examples described above or below (e.g. FIGS. 1a to 6, 7 to 15). The method may comprise one or more additional optional features corresponding to one or more aspects of the proposed concept or one or more examples described above or below.

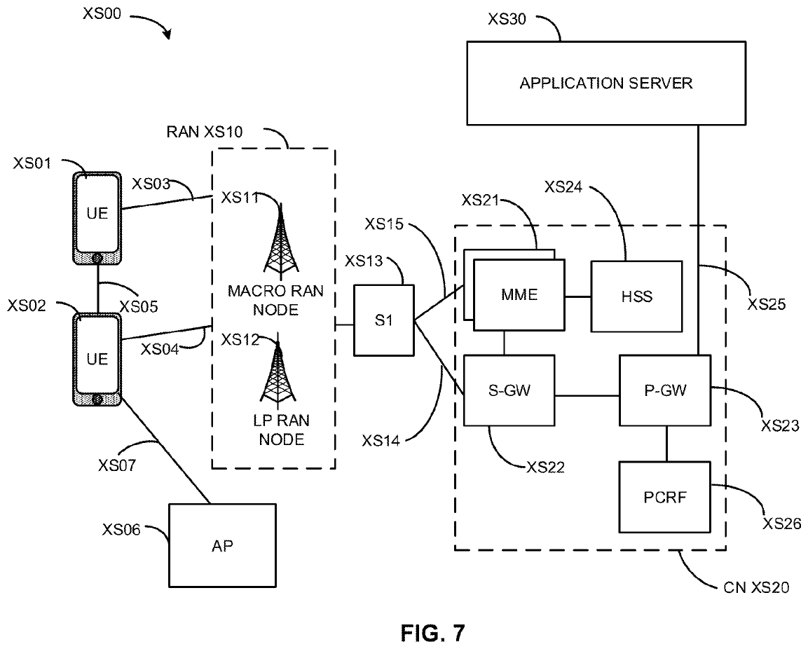

FIG. 7 illustrates an architecture of a system XS00 of a network in accordance with some embodiments. The system XS00 is shown to include a user equipment (UE) XS01 and a UE XS02. The UEs XS01 and XS02 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs XS01 and XS02 can comprise an Internet of Things (IoT) UE, which can comprise a network access layer designed for low-power IoT applications utilizing short-lived UE connections. An IoT UE can utilize technologies such as ma-chine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs XS01 and XS02 may be configured to connect, e.g., communicatively couple, with a radio access network (RAN) XS10—the RAN XS10 may be, for example, an Evolved Universal Mobile Telecommunications System (UMTS) Terrestrial Radio Access Network (E-UTRAN), a NextGen RAN (NG RAN), or some other type of RAN. The UEs XS01 and XS02 utilize connections XS03 and XS04, respectively, each of which comprises a physical communications interface or layer (discussed in further detail below); in this embodiment, the connections XS03 and XS04 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this example, the UEs XS01 and XS02 may further directly exchange communication data via a ProSe interface XS05. The ProSe interface XS05 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE XS02 is shown to be configured to access an access point (AP) XS06 via connection XS07. The connection XS07 can comprise a local wireless connection, such as a connection consistent with any IEEE 802.11 protocol, wherein the AP XS06 would comprise a wireless fidelity (WiFi®) router. In this example, the AP XS06 is shown to be connected to the Internet without connecting to the core network of the wireless system (described in further detail below).

The RAN XS10 can include one or more access nodes that enable the connections XS03 and XS04. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN XS10 may include one or more RAN nodes for providing macrocells, e.g., macro RAN node XS11, and one or more RAN nodes for providing femtocells or picocells (e.g., cells having smaller coverage areas, smaller user capacity, or higher bandwidth compared to macrocells), e.g., low power (LP) RAN node XS12.

Any of the RAN nodes XS11 and XS12 can terminate the air interface protocol and can be the first point of contact for the UEs XS01 and XS02. In some embodiments, any of the RAN nodes XS11 and XS12 can fulfill various logical functions for the RAN XS10 including, but not limited to, radio network controller (RNC) functions such as radio bearer management, uplink and downlink dynamic radio resource management and data packet scheduling, and mobility management.

In accordance with some embodiments, the UEs XS01 and XS02 can be configured to communicate using Orthogonal Frequency-Division Multiplexing (OFDM) communication signals with each other or with any of the RAN nodes XS11 and XS12 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes XS11 and XS12 to the UEs XS01 and XS02, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs XS01 and XS02. The physical downlink control channel (PDCCH) may carry information about the transport format and resource allocations related to the PDSCH channel, among other things. It may also inform the UEs XS01 and XS02 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes XS11 and XS12 based on channel quality information fed back from any of the UEs XS01 and XS02. The downlink resource assignment information may be sent on the PDCCH used for (e.g., assigned to) each of the UEs XS01 and XS02.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN XS10 is shown to be communicatively coupled to a core network (CN) XS20—via an S1 interface XS13. In embodiments, the CN XS20 may be an evolved packet core (EPC) network, a NextGen Packet Core (NPC) network, or some other type of CN. In this example the S1 interface XS13 is split into two parts: the S1-U interface XS14, which carries traffic data between the RAN nodes XS11 and XS12 and the serving gateway (S-GW) XS22, and the S1-mobility management entity (MME) interface XS15, which is a signaling interface between the RAN nodes XS11 and XS12 and MMEs XS21.

In this example, the CN XS20 comprises the MMEs XS21, the S-GW XS22, the Packet Data Network (PDN) Gateway (P-GW) XS23, and a home subscriber server (HSS) XS24. The MMEs XS21 may be similar in function to the control plane of legacy Serving General Packet Radio Service (GPRS) Support Nodes (SGSN). The MMEs XS21 may manage mobility aspects in access such as gateway selection and tracking area list management. The HSS XS24 may comprise a database for network users, including subscription-related information to support the network entities' handling of communication sessions. The CN XS20 may comprise one or several HSSs XS24, depending on the number of mobile subscribers, on the capacity of the equipment, on the organization of the network, etc. For example, the HSS XS24 can provide support for routing/roaming, authentication, authorization, naming/addressing resolution, location dependencies, etc.

The S-GW XS22 may terminate the S1 interface XS13 towards the RAN XS10, and routes data packets between the RAN XS10 and the CN XS20. In addition, the S-GW XS22 may be a local mobility anchor point for inter-RAN node handovers and also may provide an anchor for inter-3GPP mobility. Other responsibilities may include lawful intercept, charging, and some policy enforcement.

The P-GW XS23 may terminate an SGi interface toward a PDN. The P-GW XS23 may route data packets between the EPC network XS23 and external networks such as a network including the application server XS30 (alternatively referred to as application function (AF)) via an Internet Protocol (IP) interface XS25. Generally, the application server XS30 may be an element offering applications that use IP bearer resources with the core network (e.g., UMTS Packet Services (PS) domain, LTE PS data services, etc.). In this example, the P-GW XS23 is shown to be communicatively coupled to an application server XS30 via an IP communications interface XS25. The application server XS30 can also be configured to support one or more communication services (e.g., Voice-over-Internet Protocol (VoIP) sessions, PTT sessions, group communication sessions, social networking services, etc.) for the UEs XS01 and XS02 via the CN XS20.

The P-GW XS23 may further be a node for policy enforcement and charging data collection. Policy and Charging Enforcement Function (PCRF) XS26 is the policy and charging control element of the CN XS20. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF XS26 may be communicatively coupled to the application server XS30 via the P-GW XS23. The application server XS30 may signal the PCRF XS26 to indicate a new service flow and select the appropriate Quality of Service (QoS) and charging parameters. The PCRF XS26 may provision this rule into a Policy and Charging Enforcement Function (PCEF) (not shown) with the appropriate traffic flow template (TFT) and QoS class of identifier (QCI), which commences the QoS and charging as specified by the application server XS30.

FIG. 8 illustrates example components of a device XT00 in accordance with some embodiments. In some embodiments, the device XT00 may include application circuitry XT02, baseband circuitry XT04, Radio Frequency (RF) circuitry XT06, front-end module (FEM) circuitry XT08, one or more antennas XT10, and power management circuitry (PMC) XT12 coupled together at least as shown. The components of the illustrated device XT00 may be included in a UE or a RAN node. In some embodiments, the device XT00 may include less elements (e.g., a RAN node may not utilize application circuitry XT02, and instead include a processor/controller to process IP data received from an EPC). In some embodiments, the device XT00 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry XT02 may include one or more application processors. For example, the application circuitry XT02 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device XT00. In some embodiments, processors of application circuitry XT02 may process IP data packets received from an EPC.

The baseband circuitry XT04 may include circuitry such as, but not limited to, one or more single-core or multi-core processors. The baseband circuitry XT04 may include one or more baseband processors or control logic to process baseband signals received from a receive signal path of the RF circuitry XT06 and to generate baseband signals for a transmit signal path of the RF circuitry XT06. Baseband processing circuitry XT04 may interface with the application circuitry XT02 for generation and processing of the baseband signals and for controlling operations of the RF circuitry XT06. For example, in some embodiments, the baseband circuitry XT04 may include a third generation (3G) baseband processor XT04A, a fourth generation (4G) baseband processor XT04B, a fifth generation (5G) baseband processor XT04C, or other baseband processor(s) XT04D for other existing generations, generations in development or to be developed in the future (e.g., second generation (2G), sixth generation (6G), etc.). The baseband circuitry XT04 (e.g., one or more of baseband processors XT04A-D) may handle various radio control functions that enable communication with one or more radio networks via the RF circuitry XT06. In other embodiments, some or all of the functionality of baseband processors XT04A-D may be included in modules stored in the memory XT04G and executed via a Central Processing Unit (CPU) XT04E. The radio control functions may include, but are not limited to, signal modulation/demodulation, encoding/decoding, radio frequency shifting, etc. In some embodiments, modulation/demodulation circuitry of the baseband circuitry XT04 may include Fast-Fourier Transform (FFT), precoding, or constellation mapping/demapping functionality. In some embodiments, encoding/decoding circuitry of the baseband circuitry XT04 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry XT04 may include one or more audio digital signal processor(s) (DSP) XT04F. The audio DSP(s) XT04F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry XT04 and the application circuitry XT02 may be implemented together such as, for example, on a system on a chip (SOC).

In some embodiments, the baseband circuitry XT04 may provide for communication compatible with one or more radio technologies. For example, in some embodiments, the baseband circuitry XT04 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry XT04 is configured to support radio communications of more than one wireless protocol may be referred to as multi-mode baseband circuitry.

RF circuitry XT06 may enable communication with wireless networks using modulated electromagnetic radiation through a non-solid medium. In various embodiments, the RF circuitry XT06 may include switches, filters, amplifiers, etc. to facilitate the communication with the wireless network. RF circuitry XT06 may include a receive signal path which may include circuitry to down-convert RF signals received from the FEM circuitry XT08 and provide baseband signals to the baseband circuitry XT04. RF circuitry XT06 may also include a transmit signal path which may include circuitry to up-convert baseband signals provided by the baseband circuitry XT04 and provide RF output signals to the FEM circuitry XT08 for transmission.

In some embodiments, the receive signal path of the RF circuitry XT06 may include mixer circuitry XT06a, amplifier circuitry XT06b and filter circuitry XT06c. In some embodiments, the transmit signal path of the RF circuitry XT06 may include filter circuitry XT06c and mixer circuitry XT06a. RF circuitry XT06 may also include synthesizer circuitry XT06d for synthesizing a frequency for use by the mixer circuitry XT06a of the receive signal path and the transmit signal path. In some embodiments, the mixer circuitry XT06a of the receive signal path may be configured to down-convert RF signals received from the FEM circuitry XT08 based on the synthesized frequency provided by synthesizer circuitry XT06d. The amplifier circuitry XT06b may be configured to amplify the down-converted signals and the filter circuitry XT06c may be a low-pass filter (LPF) or band-pass filter (BPF) configured to remove unwanted signals from the down-converted signals to generate output baseband signals. Output baseband signals may be provided to the baseband circuitry XT04 for further processing. In some embodiments, the output baseband signals may be zero-frequency baseband signals, although this is not a requirement. In some embodiments, mixer circuitry XT06a of the receive signal path may comprise passive mixers, although the scope of the embodiments is not limited in this respect.

In some embodiments, the mixer circuitry XT06a of the transmit signal path may be configured to up-convert input baseband signals based on the synthesized frequency provided by the synthesizer circuitry XT06d to generate RF output signals for the FEM circuitry XT08.

The baseband signals may be provided by the baseband circuitry XT04 and may be filtered by filter circuitry XT06c.

In some embodiments, the mixer circuitry XT06a of the receive signal path and the mixer circuitry XT06a of the transmit signal path may include two or more mixers and may be arranged for quadrature downconversion and upconversion, respectively. In some embodiments, the mixer circuitry XT06a of the receive signal path and the mixer circuitry XT06a of the transmit signal path may include two or more mixers and may be arranged for image rejection (e.g., Hartley image rejection). In some embodiments, the mixer circuitry XT06a of the receive signal path and the mixer circuitry XT06a may be arranged for direct downconversion and direct upconversion, respectively. In some embodiments, the mixer circuitry XT06a of the receive signal path and the mixer circuitry XT06a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry XT06 may include analog-to-digital converter (ADC) and digital-to-analog converter (DAC) circuitry and the baseband circuitry XT04 may include a digital baseband interface to communicate with the RF circuitry XT06.

In some dual-mode embodiments, a separate radio IC circuitry may be provided for processing signals for each spectrum, although the scope of the embodiments is not limited in this respect.

In some embodiments, the synthesizer circuitry XT06d may be a fractional-N synthesizer or a fractional N/N+1 synthesizer, although the scope of the embodiments is not limited in this respect as other types of frequency synthesizers may be suitable. For example, synthesizer circuitry XT06d may be a delta-sigma synthesizer, a frequency multiplier, or a synthesizer comprising a phase-locked loop with a frequency divider.

The synthesizer circuitry XT06d may be configured to synthesize an output frequency for use by the mixer circuitry XT06a of the RF circuitry XT06 based on a frequency input and a divider control input. In some embodiments, the synthesizer circuitry XT06d may be a fractional N/N+1 synthesizer.

In some embodiments, frequency input may be provided by a voltage controlled oscillator (VCO), although that is not a requirement. Divider control input may be provided by either the baseband circuitry XT04 or the applications processor XT02 depending on the desired output frequency. In some embodiments, a divider control input (e.g., N) may be determined from a look-up table based on a channel indicated by the applications processor XT02.

Synthesizer circuitry XT06d of the RF circuitry XT06 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry XT06d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry XT06 may include an IQ/polar converter.

FEM circuitry XT08 may include a receive signal path which may include circuitry configured to operate on RF signals received from one or more antennas XT10, amplify the received signals and provide the amplified versions of the received signals to the RF circuitry XT06 for further processing. FEM circuitry XT08 may also include a transmit signal path which may include circuitry configured to amplify signals for transmission provided by the RF circuitry XT06 for transmission by one or more of the one or more antennas XT10. In various embodiments, the amplification through the transmit or receive signal paths may be done solely in the RF circuitry XT06, solely in the FEM XT08, or in both the RF circuitry XT06 and the FEM XT08.

In some embodiments, the FEM circuitry XT08 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry XT06). The transmit signal path of the FEM circuitry XT08 may include a power amplifier (PA) to amplify input RF signals (e.g., provided by RF circuitry XT06), and one or more filters to generate RF signals for subsequent transmission (e.g., by one or more of the one or more antennas XT10).

In some embodiments, the PMC XT12 may manage power provided to the baseband circuitry XT04. In particular, the PMC XT12 may control power-source selection, voltage scaling, battery charging, or DC-to-DC conversion. The PMC XT12 may often be included when the device XT00 is capable of being powered by a battery, for example, when the device is included in a UE. The PMC XT12 may increase the power conversion efficiency while providing desirable implementation size and heat dissipation characteristics.

While FIG. 8 shows the PMC XT12 coupled only with the baseband circuitry XT04. However, in other embodiments, the PMC XT 12 may be additionally or alternatively coupled with, and perform similar power management operations for, other components such as, but not limited to, application circuitry XT02, RF circuitry XT06, or FEM XT08.

In some embodiments, the PMC XT12 may control, or otherwise be part of, various power saving mechanisms of the device XT00. For example, if the device XT00 is in an RRC_Connected state, where it is still connected to the RAN node as it expects to receive traffic shortly, then it may enter a state known as Discontinuous Reception Mode (DRX) after a period of inactivity. During this state, the device XT00 may power down for brief intervals of time and thus save power.

If there is no data traffic activity for an extended period of time, then the device XT00 may transition off to an RRC_Idle state, where it disconnects from the network and does not perform operations such as channel quality feedback, handover, etc. The device XT00 goes into a very low power state and it performs paging where again it periodically wakes up to listen to the network and then powers down again. The device XT00 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry XT02 and processors of the baseband circuitry XT04 may be used to execute elements of one or more instances of a protocol stack. For example, processors of the baseband circuitry XT04, alone or in combination, may be used execute Layer 3, Layer 2, or Layer 1 functionality, while processors of the application circuitry XT04 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 9 illustrates example interfaces 12, 22, 32 of baseband circuitry in accordance with some embodiments. As discussed above, the baseband circuitry XT04 of FIG. 8 may comprise processors XT04A-XT04E and a memory XT04G utilized by said processors. Each of the processors XT04A-XT04E may include a memory interface, XU04A-XU04E, respectively, to send/receive data to/from the memory XT04G.

The baseband circuitry XT04 may further include one or more interfaces (e.g. interfaces 12, 22, 32) to communicatively couple to other circuitries/devices, such as a memory interface XU12 (e.g., an interface to send/receive data to/from memory external to the baseband circuitry XT04), an application circuitry interface XU14 (e.g., an interface to send/receive data to/from the application circuitry XT02 of FIG. 8), an RF circuitry interface XU16 (e.g., an interface to send/receive data to/from RF circuitry XT06 of FIG. 8), a wireless hardware connectivity interface XU18 (e.g., an interface to send/receive data to/from Near Field Communication (NFC) components, Bluetooth® components (e.g., Bluetooth® Low Energy), Wi-Fi® components, and other communication components), and a power management interface XU20 (e.g., an interface to send/receive power or control signals to/from the PMC XT12).

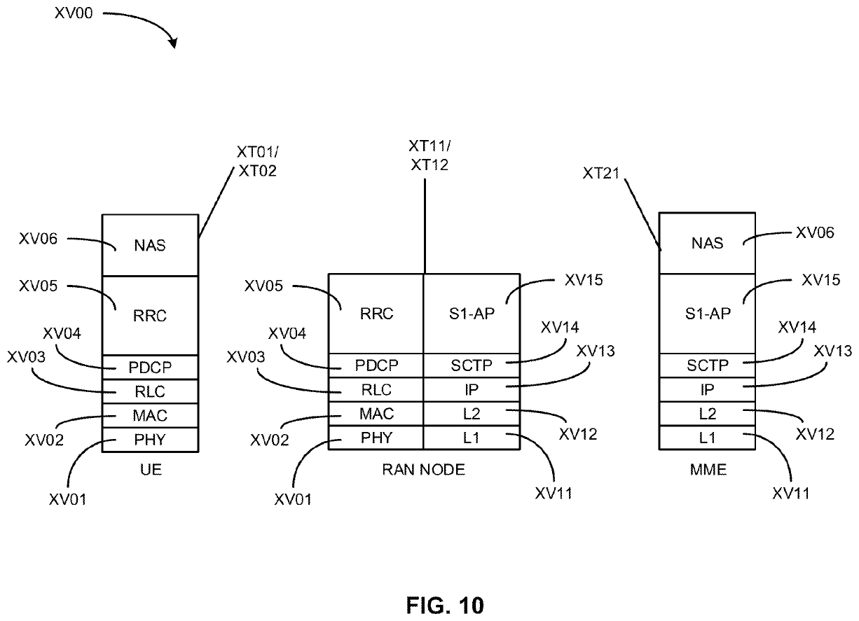

FIG. 10 is an illustration of a control plane protocol stack in accordance with some embodiments. In this example, a control plane XV00 is shown as a communications protocol stack between the UE XS01 (or alternatively, the UE XS02), the RAN node XS11 (or alternatively, the RAN node XS12), and the MME XS21.

The PHY layer XV01 may transmit or receive information used by the MAC layer XV02 over one or more air interfaces. The PHY layer XV01 may further perform link adaptation or adaptive modulation and coding (AMC), power control, cell search (e.g., for initial synchronization and handover purposes), and other measurements used by higher layers, such as the RRC layer XV05. The PHY layer XV01 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer XV02 may perform mapping between logical channels and transport channel s, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer XV03 may operate in a plurality of modes of operation, including: Transparent Mode (TM), Unacknowledged Mode (UM), and Acknowledged Mode (AM). The RLC layer XV03 may execute transfer of upper layer protocol data units (PDUs), error correction through automatic repeat request (ARQ) for AM data transfers, and concatenation, segmentation and reassembly of RLC SDUs for UM and AM data transfers. The RLC layer XV03 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer XV04 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer XV05 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE XS01 and the RAN node XS11 may utilize a Uu interface (e.g., an LTE-Uu interface) to exchange control plane data via a protocol stack comprising the PHY layer XV01, the MAC layer XV02, the RLC layer XV03, the PDCP layer XV04, and the RRC layer XV05.

The non-access stratum (NAS) protocols XV06 form the highest stratum of the control plane between the UE XS01 and the MME XS21. The NAS protocols XV06 support the mobility of the UE XS01 and the session management procedures to establish and maintain IP connectivity between the UE XS01 and the P-GW XS23.

The S1 Application Protocol (S1-AP) layer XV15 may support the functions of the S1 interface and comprise Elementary Procedures (EPs). An EP is a unit of interaction between the RAN node XS11 and the CN XS20. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) XV14 may ensure reliable delivery of signaling messages between the RAN node XS11 and the MME XS21 based, in part, on the IP protocol, supported by the IP layer XV13. The L2 layer XV12 and the L1 layer XV11 may refer to communication links (e.g., wired or wireless) used by the RAN node and the MME to exchange information.

The RAN node XS11 and the MME XS21 may utilize an S1-MME interface to exchange control plane data via a protocol stack comprising the L1 layer XV11, the L2 layer XV12, the IP layer XV13, the SCTP layer XV14, and the S1-AP layer XV15.

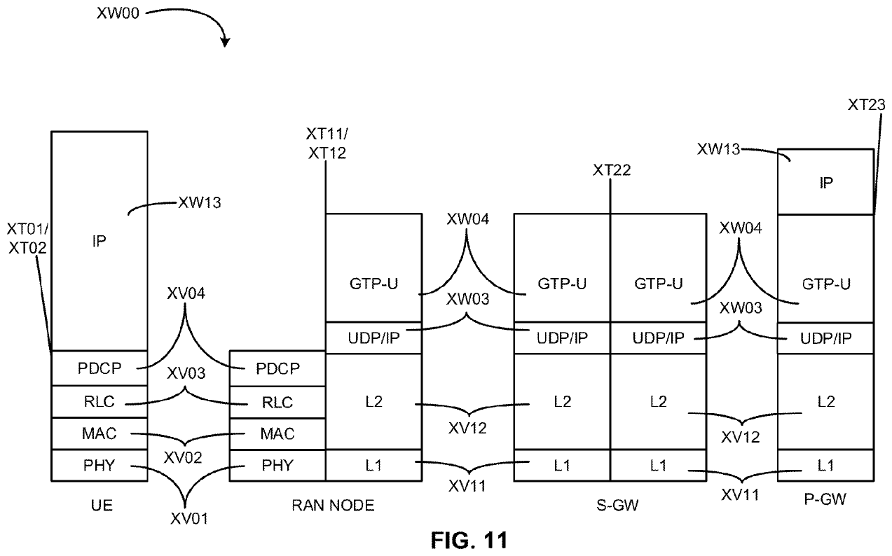

FIG. 11 is an illustration of a user plane protocol stack in accordance with some embodiments. In this example, a user plane XW00 is shown as a communications protocol stack between the UE XS01 (or alternatively, the UE XS02), the RAN node XS11 (or alternatively, the RAN node XS12), the S-GW XS22, and the P-GW XS23. The user plane WOO may utilize at least some of the same protocol layers as the control plane XV00. For example, the UE XS01 and the RAN node XS11 may utilize a Uu interface (e.g., an LTE-Uu interface) to exchange user plane data via a protocol stack comprising the PHY layer XV01, the MAC layer XV02, the RLC layer XV03, the PDCP layer XV04.

The General Packet Radio Service (GPRS) Tunneling Protocol for the user plane (GTP-U) layer XW04 may be used for carrying user data within the GPRS core network and between the radio access network and the core network. The user data transported can be packets in any of IPv4, IPv6, or PPP formats, for example. The UDP and IP security (UDP/IP) layer XW03 may provide checksums for data integrity, port numbers for addressing different functions at the source and destination, and encryption and authentication on the selected data flows. The RAN node XS11 and the S-GW XS22 may utilize an S1-U interface to exchange user plane data via a protocol stack comprising the L1 layer XV11, the L2 layer XV12, the UDP/IP layer XW03, and the GTP-U layer XW04. The S-GW XS22 and the P-GW XS23 may utilize an S5/S8a interface to exchange user plane data via a protocol stack comprising the L1 layer XV11, the L2 layer XV12, the UDP/IP layer XW03, and the GTP-U layer XW04. As discussed above with respect to FIG. 10, NAS protocols support the mobility of the UE XS01 and the session management procedures to establish and maintain IP connectivity between the UE XS01 and the P-GW XS23.

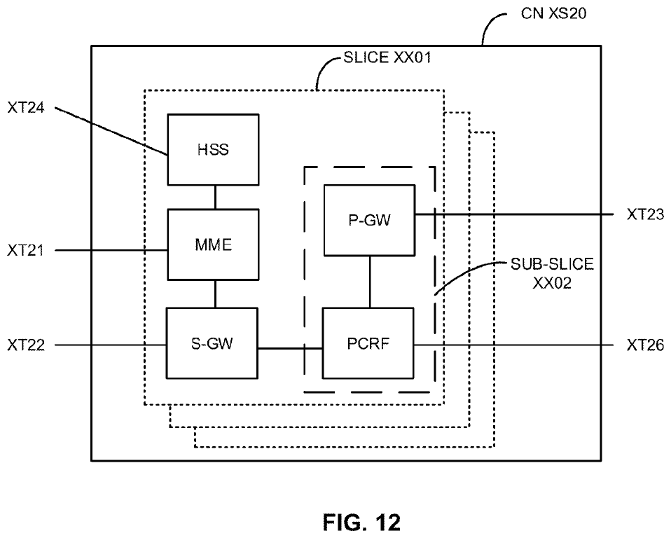

FIG. 12 illustrates components of a core network in accordance with some embodiments. The components of the CN XS20 may be implemented in one physical node or separate physical nodes including components to read and execute instructions from a machine-readable or computer-readable medium (e.g., a non-transitory machine-readable storage medium). In some embodiments, Network Functions Virtualization (NFV) is utilized to virtualize any or all of the above described network node functions via executable instructions stored in one or more computer readable storage mediums (described in further detail below). A logical instantiation of the CN XS20 may be referred to as a network slice XX01. A logical instantiation of a portion of the CN XS20 may be referred to as a network sub-slice XX02 (e.g., the network sub-slice XX02 is shown to include the PGW XS23 and the PCRF XS26).

NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

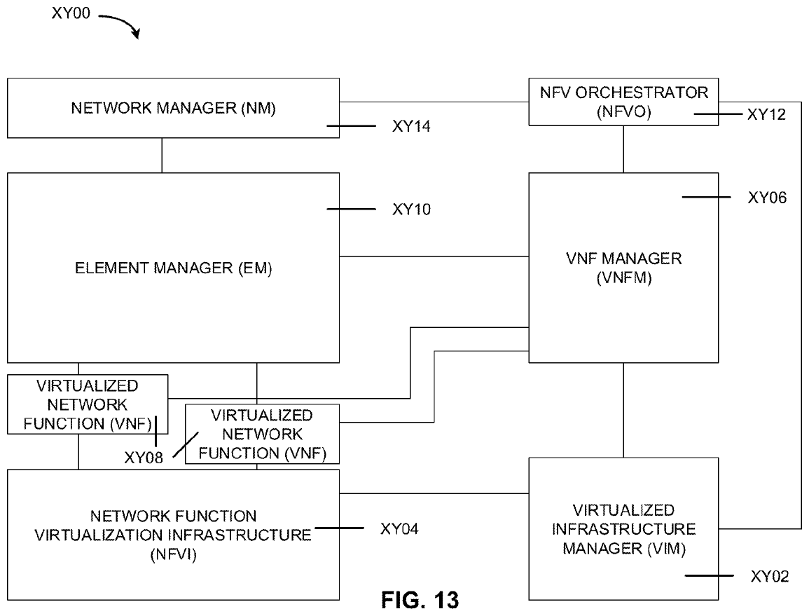

FIG. 13 is a block diagram illustrating components, according to some example embodiments, of a system XY00 to support NFV. The system XY00 is illustrated as including a virtualized infrastructure manager (VIM) XY02, a network function virtualization infrastructure (NFVI) XY04, a VNF manager (VNFM) XY06, virtualized network functions (VNFs) XY08, an element manager (EM) XY10, an NFV Orchestrator (NFVO) XY12, and a network manager (NM) XY14.

The VIM XY02 manages the resources of the NFVI XY04. The NFVI XY04 can include physical or virtual resources and applications (including hypervisors) used to execute the system XY00. The VIM XY02 may manage the life cycle of virtual resources with the NFVI XY04 (e.g., creation, maintenance, and tear down of virtual machines (VMs) associated with one or more physical resources), track VM instances, track performance, fault and security of VM instances and associated physical resources, and expose VM instances and associated physical resources to other management systems.

The VNFM XY06 may manage the VNFs XY08. The VNFs XY08 may be used to execute EPC components/functions. The VNFM XY06 may manage the life cycle of the VNFs XY08 and track performance, fault and security of the virtual aspects of VNFs XY08. The EM XY10 may track the performance, fault and security of the functional aspects of VNFs XY08. The tracking data from the VNFM XY06 and the EM XY10 may comprise, for example, performance measurement (PM) data used by the VIM XY02 or the NFVI XY04. Both the VNFM XY06 and the EM XY10 can scale up/down the quantity of VNFs of the system XY00.

The NFVO XY12 may coordinate, authorize, release and engage resources of the NFVI XY04 in order to provide the requested service (e.g., to execute an EPC function, component, or slice). The NM XY14 may provide a package of end-user functions with the responsibility for the management of a network, which may include network elements with VNFs, non-virtualized network functions, or both (management of the VNFs may occur via the EM XY10).

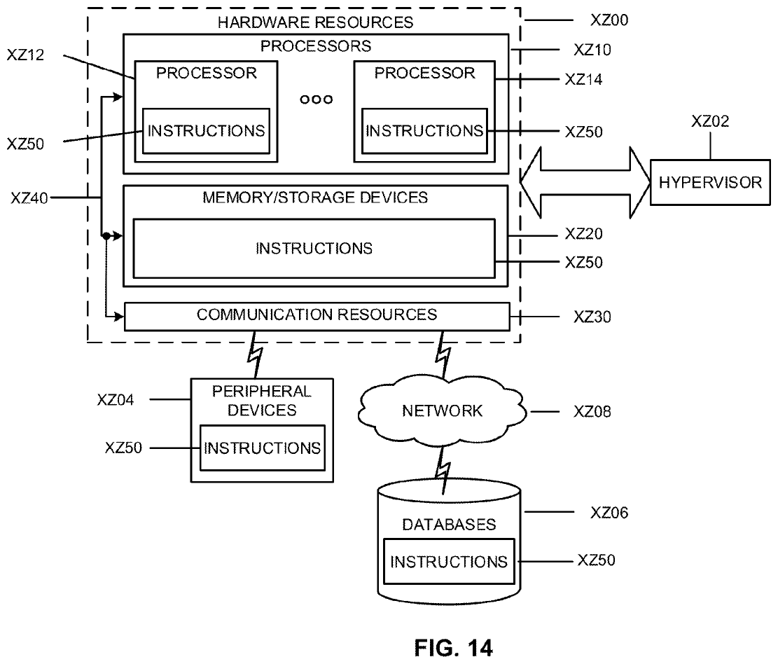

FIG. 14 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources XZ00 including one or more processors (or processor cores) XZ10, one or more memory/storage devices XZ20, and one or more communication resources XZ30, each of which may be communicatively coupled via a bus XZ40. For embodiments where node virtualization (e.g., NFV) is utilized, a hypervisor XZ02 may be executed to provide an execution environment for one or more network slices/sub-slices to utilize the hardware resources XZ00.

The processors XZ10 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor XZ12 and a processor XZ14.

The memory/storage devices XZ20 may include main memory, disk storage, or any suitable combination thereof. The memory/storage devices XZ20 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources XZ30 may include interconnection or network interface components or other suitable devices to communicate with one or more peripheral devices XZ04 or one or more databases XZ06 via a network XZ08. For example, the communication resources XZ30 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions XZ50 may comprise software, a program, an application, an applet, an app, or other executable code for causing at least any of the processors XZ10 to perform any one or more of the methodologies discussed herein. The instructions XZ50 may reside, completely or partially, within at least one of the processors XZ10 (e.g., within the processor's cache memory), the memory/storage devices XZ20, or any suitable combination thereof. Furthermore, any portion of the instructions XZ50 may be transferred to the hardware resources XZ00 from any combination of the peripheral devices XZ04 or the databases XZ06. Accordingly, the memory of processors XZ10, the memory/storage devices XZ20, the peripheral devices XZ04, and the databases XZ06 are examples of computer-readable and machine-readable media.

In some embodiments, the electronic device(s), network(s), system(s), chip(s) or component(s), or portions or implementations thereof, of any figure herein may be configured to perform one or more processes, techniques, or methods as described herein, or portions thereof.

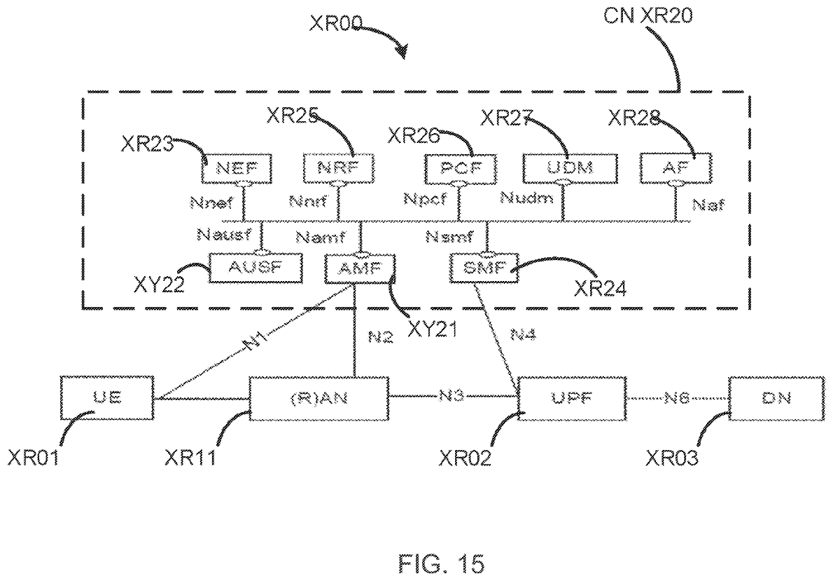

FIG. 15 illustrates an architecture of a system XR00 of a network in accordance with some embodiments. The system XR00 is shown to include a UE XR01, which may be the same or similar to UEs XS01 and XS02 discussed previously; a RAN node XR11, which may be the same or similar to RAN nodes XS11 and XS12 discussed previously; a User Plane Function (UPF) XR02; a Data network (DN) XR03, which may be, for example, operator services, Internet access or 3rd party services; and a 5G Core Network (5GC or CN) XR20.

The CN XR20 may include an Authentication Server Function (AUSF) XR22; a Core Access and Mobility Management Function (AMF) XR21; a Session Management Function (SMF) XR24; a Network Exposure Function (NEF) XR23; a Policy Control function (PCF) XR26; a Network Function (NF) Repository Function (NRF) XR25; a Unified Data Management (UDM) XR27; and an Application Function (AF) XR28. The CN XR20 may also include other elements that are not shown, such as a Structured Data Storage network function (SDSF), an Unstructured Data Storage network function (UDSF), and the like.

The UPF XR02 may act as an anchor point for intra-RAT and inter-RAT mobility, an external PDU session point of interconnect to DN XR03, and a branching point to support multi-homed PDU session. The UPF XR02 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in the uplink and downlink, and downlink packet buffering and downlink data notification triggering. UPF XR02 may include an uplink classifier to support routing traffic flows to a data network. The DN XR03 may represent various network operator services, Internet access, or third party services. NY XR03 may include, or be similar to application server XS30 discussed previously.

The AUSF XR22 may store data for authentication of UE XR01 and handle authentication related functionality. The AUSF XR22 may facilitate a common authentication framework for various access types. The AMF XR21 may be responsible for registration management (e.g., for registering UE XR01, etc.), connection management, reachability management, mobility management, and lawful interception of AMF-related events, and access authentication and authorization. AMF XR21 may provide transport for SM messages between and SMF XR24, and act as a transparent proxy for routing SM messages.

AMF XR21 may also provide transport for short message service (SMS) messages between UE XR01 and an SMS function (SMSF) (not shown by FIG. 15). AMF XR21 may act as Security Anchor Function (SEA), which may include interaction with the AUSF XR22 and the UE XR01, receipt of an intermediate key that was established as a result of the UE XR01 authentication process. Where USIM based authentication is used, the AMF XR21 may retrieve the security material from the AUSF XR22. AMF XR21 may also include a Security Context Management (SCM) function, which receives a key from the SEA that it uses to derive access-network specific keys. Furthermore, AMF XR21 may be a termination point of RAN CP interface (N2 reference point), a termination point of NAS (NI) signalling, and perform NAS ciphering and integrity protection.

AMF XR21 may also support NAS signalling with a UE XR01 over an N3 interworking-function (IWF) interface. The N3IWF may be used to provide access to untrusted entities. N33IWF may be a termination point for the N2 and N3 interfaces for control plane and user plane, respectively, and as such, may handle N2 signalling from SMF and AMF for PDU sessions and QoS, encapsulate/de-encapsulate packets for IPSec and N3 tunneling, mark N3 user-plane packets in the uplink, and enforce QoS corresponding to N3 packet marking taking into account QoS requirements associated to such marking received over N2. N3IWF may also relay uplink and downlink control-plane NAS (NI) signalling between the UE XR01 and AMF XR21, and relay uplink and downlink user-plane packets between the UE XR01 and UPF XR02. The N3IWF also provides mechanisms for IPsec tunnel establishment with the UE XR01.

The SMF XR24 may be responsible for session management (e.g., session establishment, modify and release, including tunnel maintain between UPF and AN node); UE IP ad-dress allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. The SMF XR24 may include the following roaming functionality: handle local enforcement to apply QoS SLAs (VPLMN); charging data collection and charging interface (VPLMN); lawful intercept (in VPLMN for SM events and interface to LI System); support for interaction with external DN for transport of signalling for PDU session authorization/authentication by external DN.

The NEF XR23 may provide means for securely exposing the services and capabilities provided by 3GPP network functions for third party, internal exposure/re-exposure, Application Functions (e.g., AF XR28), edge computing or fog computing systems, etc. In such embodiments, the NEF XR23 may authenticate, authorize, and/or throttle the AFs. NEF XR23 may also translate information exchanged with the AF XR28 and information exchanged with internal network functions. For example, the NEF XR23 may translate between an AF-Service-Identifier and an internal 5GC information. NEF XR23 may also receive information from other network functions (NFs) based on exposed capabilities of other network functions. This information may be stored at the NEF XR23 as structured data, or at a data storage NF using a standardized interfaces. The stored information can then be re-exposed by the NEF XR23 to other NFs and AFs, and/or used for other purposes such as analytics.

The NRF XR25 may support service discovery functions, receive NF Discovery Requests from NF instances, and provide the information of the discovered NF instances to the NF instances. NRF XR25 also maintains information of available NF instances and their supported services.

The PCF XR26 may provide policy rules to control plane function(s) to enforce them, and may also support unified policy framework to govern network behaviour. The PCF XR26 may also implement a front end (FE) to access subscription information relevant for policy decisions in a UDR of UDM XR27.

The UDM XR27 may handle subscription-related information to support the network entities' handling of communication sessions, and may store subscription data of UE XR01. The UDM XR27 may include two parts, an application FE and a User Data Repository (UDR). The UDM may include a UDM FE, which is in charge of processing of credentials, location management, subscription management and so on. Several different front ends may serve the same user in different transactions. The UDM-FE accesses subscription information stored in the UDR and performs authentication credential processing; user identification handling; access authorization; registration/mobility management; and subscription management. The UDR may interact with PCF XR26. UDM XR27 may also support SMS management, wherein an SMS-FE implements the similar application logic as discussed previously.

The AF XR28 may provide application influence on traffic routing, access to the Network Capability Exposure (NCE), and interact with the policy framework for policy control. The NCE may be a mechanism that allows the 5GC and AF XR28 to provide information to each other via NEF XR23, which may be used for edge computing implementations. In such implementations, the network operator and third party services may be hosted close to the UE XR01 access point of attachment to achieve an efficient service delivery through the reduced end-to-end latency and load on the transport network. For edge computing implementations, the 5GC may select a UPF XR02 close to the UE XR01 and execute traffic steering from the UPF XR02 to DN XR03 via the N6 interface. This may be based on the UE subscription data, UE location, and information provided by the AF XR28. In this way, the AF XR28 may influence UPF (re)selection and traffic routing. Based on operator deployment, when AF XR28 is considered to be a trusted entity, the network operator may permit AF XR28 to interact directly with relevant NFs.

As discussed previously, the CN XR20 may include an SMSF, which may be responsible for SMS subscription checking and verification, and relaying SM messages to/from the UE XR01 to/from other entities, such as an SMS-GMSC/IWMSC/SMS-router. The SMS may also interact with AMF XR21 and UDM XR27 for notification procedure that the UE XR01 is available for SMS transfer (e.g., set a UE not reachable flag, and notifying UDM XR27 when UE XR01 is available for SMS).

The system XR00 may include the following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

The system XR00 may include the following reference points: NI: Reference point between the UE and the AMF; N2: Reference point between the (R)AN and the AMF; N3: Reference point between the (R)AN and the UPF; N4: Reference point between the SMF and the UPF; and N6: Reference point between the UPF and a Data Network. There may be many more reference points and/or service-based interfaces between the NF services in the NFs, however, these interfaces and reference points have been omitted for clarity. For example, an NS reference point may be between the PCF and the AF; an N7 reference point may be between the PCF and the SMF; an NII reference point between the AMF and SMF; etc. In some embodiments, the CN XR20 may include an Nx interface, which is an inter-CN interface between the MME (e.g., MME XS21) and the AMF XR21 in order to enable interworking between CN XR20 and CN XS20.

Although not shown by FIG. 15, system XR00 may include multiple RAN nodes XRI I wherein an Xn interface is defined between two or more RAN nodes XRI I (e.g., gNBs and the like) that connecting to 5GC XR20, between a RAN node XRI I (e.g., gNB) connecting to 5GC XR20 and an eNB (e.g., a RAN node XSI I of FIG. XS), and/or between two eNBs connecting to 5GC XR20.

In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE XR01 in a connected mode (e.g., CM-CONNECTED) including functionality to manage the UE mobility for connected mode between one or more RAN nodes XR11. The mobility support may include context transfer from an old (source) serving RAN node XR11 to new (target) serving RAN node XR11; and control of user plane tunnels between old (source) serving RAN node XR11 to new (target) serving RAN node XR11.

A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on an SCTP layer. The SCTP layer may be on top of an IP layer. The SCTP layer provides the guaranteed delivery of application layer messages. In the transport IP layer point-to-point transmission is used to deliver the signaling PDUs. In other implementations, the Xn-U protocol stack and/or the Xn-C protocol stack may be same or similar to the user plane and/or control plane protocol stack(s) shown and described herein.

The examples as described herein may be summarized as follows:

Example 1 relates to an apparatus 10 for a base station transceiver 100 of a mobile communication system 400. The apparatus 10 includes at least one interface 12 for communicating with a transceiver module 16 of the base station transceiver 100. The apparatus includes a control module 14 configured to provide a reference signal to a user equipment 200 of the mobile communication system 400 via the transceiver module 16, wherein the reference signal is a reference signal for time tracking, and provide a downlink control signal to the user equipment 200 via the transceiver module 16, wherein the reference signal and the downlink control signal are quasi-co-located.

In Example 2, the subject matter of Example 1 or any of the Examples described herein may further include, that the downlink control signal is provided via a physical downlink control channel, PDCCH, of the mobile communication system 400.

In Example 3, the subject matter of one of the previous Examples or any of the Examples described herein may further include, that the downlink control signal and the reference signal are transmitted based on the same spatial filtering parameters.

In Example 4, the subject matter of one of the previous Examples or any of the Examples described herein may further include, that the reference signal is a tracking reference signal.

In Example 5, the subject matter of one of the previous Examples or any of the Examples described herein may further include, that the reference signal is a beam-formed reference signal.

In Example 6, the subject matter of one of the previous Examples or any of the Examples described herein may further include, that the reference signal is a user equipment-specific reference signal.

In Example 7, the subject matter of one of the previous Examples or any of the Examples described herein may further include, that the reference signal is an aperiodic reference signal.

In Example 8, the subject matter of Example 7 or any of the Examples described herein may further include, that the control module 14 is configured to obtain information related a control transmission to be provided to the user equipment 200 using the downlink control signal, wherein the aperiodic reference signal is provided based on the information related to the control transmission to be provided to the user equipment 200, and wherein the control module 14 is configured to provide the control transmission to the user equipment 200 using the downlink control signal after providing the aperiodic reference signal.

In Example 9, the subject matter of one of the Examples 7 or 8 or any of the Examples described herein may further include, that the control module 14 is configured to control a number of repetitions of the aperiodic reference signal based on a time elapsed since a previous communication with the user equipment 200.

In Example 10, the subject matter of one of the previous Examples or any of the Examples described herein may further include, that the control module 14 is configured to obtain information related to a channel quality estimation of a channel between the base station transceiver 100 and the user equipment 200 from the user equipment 200 via the transceiver module 16, wherein the control module 14 is configured to control a bandwidth of the reference signal based on the information related to the channel quality estimation.

In Example 11, the subject matter of Example 10 or any of the Examples described herein may further include, that the control module 14 is configured to provide the reference signal using a first larger bandwidth if a quality of the channel quality estimation is above a quality threshold and if a size of a control transmission to be provided using the downlink control signal is above a size threshold, and wherein the control module 14 is configured to provide the reference signal using a second smaller bandwidth if a quality of the channel quality estimation is below the quality threshold or if the size of the control transmission to be provided using the downlink control signal is below the size threshold.

In Example 12, the subject matter of one of the previous Examples or any of the Examples described herein may further include, that the control module 14 is configured to obtain information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the control module 14 is configured to provide the reference signal based on the one or more time slots for the reference signal.

In Example 13, the subject matter of Example 12 or any of the Examples described herein may further include, that the control module 14 is configured to determine the information related to the control channel configuration, wherein the control module 14 is configured to provide the information related to the control channel configuration to the user equipment 200.

Example 14 relates to an apparatus 20 for a user equipment 200 of a mobile communication system 400. The apparatus 20 includes at least one interface 22 for communicating with a transceiver module 26 of the user equipment 200. The apparatus 20 includes a control module 24 configured to obtain a reference signal from a base station transceiver 100 of the mobile communication system 400 via the transceiver module 26, wherein the reference signal is a reference signal for time tracking. The control module is configured to obtain a downlink control signal from the base station transceiver 100 via the transceiver module 26, wherein the reference signal and the downlink control signal are quasi-co-located.

In Example 15, the subject matter of Example 14 or any of the Examples described herein may further include, that the control module 24 is configured to decode the downlink control signal based on the obtained reference signal.

In Example 16, the subject matter of one of the Examples 14 or 15 or any of the Examples described herein may further include, that the control module 24 is configured to obtain the downlink control signal via the transceiver module 26 at a first time interval if the reference signal is obtained within a second time interval, wherein the second time interval lies before the first time interval.

In Example 17, the subject matter of one of the Examples 14 to 16 or any of the Examples described herein may further include, that the control module 24 is configured to obtain a further reference signal from the base station transceiver 100 via the transceiver module 26, wherein the control module 24 is configured to determine a channel estimation for a channel between the base station transceiver 100 and the user equipment 200 based on the further reference signal, wherein the control module 24 is configured to refine the channel estimation based on the reference signal.

In Example 18, the subject matter of one of the Examples 14 to 17 or any of the Examples described herein may further include, that the control module 24 is configured to determine a channel quality estimation of a channel between the base station transceiver 100 and the user equipment 200, wherein the control module is configured to provide information related to the channel quality estimation to the base station transceiver 100, wherein a bandwidth of the reference signal is based on the provided information related to the channel quality estimation.

In Example 19, the subject matter of one of the Examples 14 to 18 or any of the Examples described herein may further include, that the control module 24 is configured to determine a power delay profile based on the reference signal.

In Example 20, the subject matter of Example 19 or any of the Examples described herein may further include, that the reference signal is a periodic reference signal, wherein the control module 24 is configured to refine the power delay profile continuously based on the periodic reference signal.

In Example 21, the subject matter of one of the Examples 19 or 20 or any of the Examples described herein may further include, that the control module 24 is configured to obtain a demodulation reference signal associated with the downlink control signal via the transceiver module 26, wherein the control module 24 is configured to determine the power delay profile based on the reference signal and based on the demodulation reference signal.

In Example 22, the subject matter of Example 21 or any of the Examples described herein may further include, that the demodulation reference signal is associated with a control transmission via the downlink control signal, wherein the control module 24 is configured to determine the power delay profile based on the reference signal and based on the demodulation reference signal if a size of the control transmission is larger than a size threshold.

In Example 23, the subject matter of one of the Examples 14 to 22 or any of the Examples described herein may further include, that the control module 24 is configured to obtain information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the control module 24 is configured to obtain the reference signal based on the one or more time slots for the reference signal.

Examples 24 relates to an apparatus 30 for an entity of a mobile communication system 400. The mobile communication system 400 includes a base station transceiver 100 and a user equipment 200. The apparatus includes at least one interface 32 for communicating with a transceiver module 36 of the entity 300. The apparatus 30 includes a control module 34 configured to determine information related to a control channel configuration, wherein the control channel configuration is suitable for a control channel for a downlink control signal, wherein the information related to the control channel configuration defines one or more time-slots for a reference signal for time tracking, wherein the control channel configuration defines the reference signal and the downlink control signal to be quasi-co-located. The control module is configured to provide the information related to the control channel configuration to the base station transceiver 100 and to the user equipment 200.

In Example 25, the subject matter of Example 24 or any of the Examples described herein may further include, that the reference signal is an aperiodic reference signal.

Example 26 relates to a gNodeB 100 including the apparatus 10 according to one of the examples 1 to 13 or any of the Examples described herein.

Example 27 relates to a user equipment 200 including the apparatus 20 according to one of the examples 14 to 23 or any of the Examples described herein.

Examples 28 relates to an entity 300 of a mobile communication system 400 including the apparatus 30 according to one of the examples 24 or 25 or any of the Examples described herein.

Example 29 relates to a mobile communication system 400 including a gNodeB 100 according to example 26 and a user equipment 200 according to example 27 or any of the Examples described herein.

In example 30, the subject matter of Example 29 or any of the Examples described herein may further include an entity 300 according to Example 28.

Example 31 relates to a device 10 for a base station transceiver 100 of a mobile communication system 400. The device 10 includes at least one means for communicating 12 for communicating with a means for transceiving 16 of the base station transceiver 100. The device 10 includes a means for controlling 14 configured for providing a reference signal to a user equipment 200 of the mobile communication system 400 via the means for transceiving 16, wherein the reference signal is a reference signal for time tracking. The means for controlling is configured for providing a downlink control signal to the user equipment 200 via the means for transceiving 16, wherein the reference signal and the downlink control signal are quasi-co-located.

In Example 32, the subject matter of Example 31 or any of the Examples described herein may further include, that the downlink control signal is provided via a physical downlink control channel, PDCCH, of the mobile communication system 400.

In Example 33, the subject matter of one of the Examples 31 to 32 or any of the Examples described herein may further include, that the downlink control signal and the reference signal are transmitted based on the same spatial filtering parameters.

In Example 34, the subject matter of one of the Examples 31 to 33 or any of the Examples described herein may further include, that the reference signal is a tracking reference signal.

In Example 35, the subject matter of one of the Examples 31 to 34 or any of the Examples described herein may further include, that the reference signal is a beam-formed reference signal.

In Example 36, the subject matter of one of the Examples 31 to 35 or any of the Examples described herein may further include, that the reference signal is a user equipment-specific reference signal.

In Example 37, the subject matter of one of the Examples 31 to 36 or any of the Examples described herein may further include, that the reference signal is an aperiodic reference signal.

In Example 38, the subject matter of Example 37 or any of the Examples described herein may further include, that the means for controlling 14 is configured for obtaining information related a control transmission to be provided to the user equipment 200 using the downlink control signal, wherein the aperiodic reference signal is provided based on the information related to the control transmission to be provided to the user equipment 200, and wherein the means for controlling 14 is configured for providing the control transmission to the user equipment 200 using the downlink control signal after providing the aperiodic reference signal.

In Example 39, the subject matter of one of the Examples 37 or 38 or any of the Examples described herein may further include, that the means for controlling 14 is configured for controlling a number of repetitions of the aperiodic reference signal based on a time elapsed since a previous communication with the user equipment 200.

In Example 40, the subject matter of one of the Examples 31 to 39 or any of the Examples described herein may further include, that the means for controlling 14 is configured for obtaining information related to a channel quality estimation of a channel between the base station transceiver 100 and the user equipment 200 from the user equipment 200 via the means for transceiving 16, wherein the means for controlling 14 is configured for controlling a bandwidth of the reference signal based on the information related to the channel quality estimation.

In Example 41, the subject matter of Example 40 or any of the Examples described herein may further include, that the means for controlling 14 is configured for providing the reference signal using a first larger bandwidth if a quality of the channel quality estimation is above a quality threshold and if a size of a control transmission to be provided using the downlink control signal is above a size threshold, and wherein the means for controlling 14 is configured for providing the reference signal using a second smaller bandwidth if a quality of the channel quality estimation is below the quality threshold or if the size of the control transmission to be provided using the downlink control signal is below the size threshold.

In Example 42, the subject matter of one of the Examples 31 to 41 or any of the Examples described herein may further include, that the means for controlling 14 is configured for obtaining information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the means for controlling 14 is configured for providing the reference signal based on the one or more time slots for the reference signal.

In Example 43, the subject matter of Example 42 or any of the Examples described herein may further include, that the means for controlling 14 is configured for determining the information related to the control channel configuration, wherein the means for controlling 14 is configured for providing the information related to the control channel configuration to the user equipment 200.

Example 44 relates to a device 20 for a user equipment 200 of a mobile communication system 400. The device 20 includes at least one means for communicating 22 for communicating with a means for transceiving 26 of the user equipment 200. The device 200 includes a means for controlling 24 configured for obtaining a reference signal from a base station transceiver 100 of the mobile communication system 400 via the means for transceiving 26, wherein the reference signal is a reference signal for time tracking. The means for controlling is configured to obtaining a downlink control signal from the base station transceiver 100 via the means for transceiving 26, wherein the reference signal and the downlink control signal are quasi-co-located.

In Example 45, the subject matter of Example 44 or any of the Examples described herein may further include, that the means for controlling 24 is configured for decoding the downlink control signal based on the obtained reference signal.

In Example 46, the subject matter of one of the Examples 44 or 45 or any of the Examples described herein may further include, that the means for controlling 24 is configured for obtaining the downlink control signal via the means for transceiving 26 at a first time interval if the reference signal is obtained within a second time interval, wherein the second time interval lies before the first time interval.

In Example 47, the subject matter of one of the Examples 44 to 46 or any of the Examples described herein may further include, that the means for controlling 24 is configured for obtaining a further reference signal from the base station transceiver 100 via the means for transceiving 26, wherein the means for controlling 24 is configured for determining a channel estimation for a channel between the base station transceiver 100 and the user equipment 200 based on the further reference signal, wherein the means for controlling 24 is configured for refining the channel estimation based on the reference signal.

In Example 48, the subject matter of one of the Examples 44 to 47 or any of the Examples described herein may further include, that the means for controlling 24 is configured for determining a channel quality estimation of a channel between the base station transceiver 100 and the user equipment 200, wherein the means for controlling is configured for providing information related to the channel quality estimation to the base station transceiver 100, wherein a bandwidth of the reference signal is based on the provided information related to the channel quality estimation.

In Example 49, the subject matter of one of the Examples 44 to 48 or any of the Examples described herein may further include, that the means for controlling 24 is configured for determining a power delay profile based on the reference signal.

In Example 50, the subject matter of Example 49 or any of the Examples described herein may further include, that the reference signal is a periodic reference signal, wherein the means for controlling 24 is configured for refining the power delay profile continuously based on the periodic reference signal.

In Example 51, the subject matter of one of the Examples 49 or 50 or any of the Examples described herein may further include, that the means for controlling 24 is configured for obtaining a demodulation reference signal associated with the downlink control signal via the means for transceiving 26, wherein the means for controlling 24 is configured for determining the power delay profile based on the reference signal and based on the demodulation reference signal.

In Example 52, the subject matter of Example 51 or any of the Examples described herein may further include, that the demodulation reference signal is associated with a control transmission via the downlink control signal, wherein the means for controlling 24 is configured for determining the power delay profile based on the reference signal and based on the demodulation reference signal if a size of the control transmission is larger than a size threshold.

In Example 53, the subject matter of one of the Examples 44 to 52 or any of the Examples described herein may further include, that the means for controlling 24 is configured for obtaining information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the means for controlling 24 is configured for obtaining the reference signal based on the one or more time slots for the reference signal.

Example 54 relates to a device 30 for an entity of a mobile communication system 400. The mobile communication system 400 includes a base station transceiver 100 and a user equipment 200. The device 30 includes a means for communicating 32 for communicating with a means for transceiving 36 of the entity 300. The device 30 includes a means for controlling 34 configured for determining information related to a control channel configuration, wherein the control channel configuration is suitable for a control channel for a downlink control signal, wherein the information related to the control channel configuration defines one or more time-slots for a reference signal for time tracking, wherein the control channel configuration defines the reference signal and the downlink control signal to be quasi-co-located. The means for controlling 34 is configured for providing the information related to the control channel configuration to the base station transceiver 100 and to the user equipment 200.

In Example 55, the subject matter of Example 54 or any of the Examples described herein may further include, that the reference signal is an aperiodic reference signal.

Example 56 relates to a gNodeB 100 including the device 10 according to one of the examples 31 to 43 or any of the Examples described herein.

Example 57 relates to a user equipment 200 including the device 20 according to one of the examples 44 to 53 or any of the Examples described herein.

Example 58 relates to an entity 300 of a mobile communication system 400 including the device 30 according to one of the examples 54 or 55 or any of the Examples described herein.

Example 59 relates to a mobile communication system 400 including a gNodeB 100 according to example 56 and a user equipment 200 according to example 57 or any of the Examples described herein.

In Example 60, the subject matter of Example 59 or any of the Examples described herein further includes an entity 300 according to Example 58.

Example 61 relates to a base station transceiver method for a base station transceiver 100 of a mobile communication system 400. The base station transceiver method includes providing 110 a reference signal to a user equipment 200 of the mobile communication system 400, wherein the reference signal is a reference signal for time tracking. The base station transceiver method includes providing 120 a downlink control signal to the user equipment 200, wherein the reference signal and the downlink control signal are quasi-co-located.

In Example 62, the subject matter of Example 61 or any of the Examples described herein may further include, that the downlink control signal is provided via a physical downlink control channel, PDCCH, of the mobile communication system 400.

In Example 63, the subject matter of one of the Examples 61 to 62 or any of the Examples described herein may further include, that the downlink control signal and the reference signal are transmitted based on the same spatial filtering parameters.

In Example 64, the subject matter of one of the Examples 61 to 63 or any of the Examples described herein may further include, that the reference signal is a tracking reference signal.

In Example 65, the subject matter of one of the Examples 61 to 64 or any of the Examples described herein may further include, that the reference signal is a beam-formed reference signal.

In Example 66, the subject matter of one of the Examples 61 to 65 or any of the Examples described herein may further include, that the reference signal is a user equipment-specific reference signal.

In Example 67, the subject matter of one of the Examples 61 to 66 or any of the Examples described herein may further include, that the reference signal is an aperiodic reference signal.

In Example 68, the subject matter of Example 67 or any of the Examples described herein may further include, that the base station transceiver method includes obtaining 130 information related a control transmission to be provided to the user equipment 200 using the downlink control signal, wherein the aperiodic reference signal is provided based on the information related to the control transmission to be provided to the user equipment 200, and wherein the base station transceiver method includes providing 132 the control transmission to the user equipment 200 using the downlink control signal after providing the aperiodic reference signal.

In Example 69, the subject matter of one of the Examples 67 or 68 or any of the Examples described herein may further include, that the base station transceiver method includes controlling 140 a number of repetitions of the aperiodic reference signal based on a time elapsed since a previous communication with the user equipment 200.

In Example 70, the subject matter of one of the Examples 61 to 69 or any of the Examples described herein may further include, that the base station transceiver method includes obtaining 150 information related to a channel quality estimation of a channel between the base station transceiver 100 and the user equipment 200 from the user equipment 200, wherein the base station transceiver method includes controlling 152 a bandwidth of the reference signal based on the information related to the channel quality estimation.

In Example 71, the subject matter of Example 70 or any of the Examples described herein may further include, that base station transceiver method includes providing 110 the reference signal using a first larger bandwidth if a quality of the channel quality estimation is above a quality threshold and if a size of a control transmission to be provided using the downlink control signal is above a size threshold, and wherein the base station transceiver method includes providing 110 the reference signal using a second smaller bandwidth if a quality of the channel quality estimation is below the quality threshold or if the size of the control transmission to be provided using the downlink control signal is below the size threshold.

In Example 72, the subject matter of one of the Examples 61 to 71 or any of the Examples described herein may further include, that the base station transceiver method includes obtaining 160 information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the base station transceiver method includes providing 110 the reference signal based on the one or more time slots for the reference signal.

In Example 73, the subject matter of Example 72 or any of the Examples described herein may further include, that the base station transceiver method includes determining 162 the information related to the control channel configuration, wherein the base station transceiver method includes providing the information related to the control channel configuration to the user equipment 200.

Example 74 relates to a user equipment method for a user equipment 200 of a mobile communication system 400. The user equipment method includes obtaining 210 a reference signal from a base station transceiver 100 of the mobile communication system 400, wherein the reference signal is a reference signal for time tracking. The user equipment method includes obtaining 220 a downlink control signal from the base station transceiver 100, wherein the reference signal and the downlink control signal are quasi-co-located.

In Example 75, the subject matter of Example 74 or any of the Examples described herein may further include, that the user equipment method includes decoding 230 the downlink control signal based on the obtained reference signal.

In Example 76, the subject matter of one of the Examples 74 or 75 or any of the Examples described herein may further include, that the user equipment method includes obtaining 220 the downlink control signal at a first time interval if the reference signal is obtained within a second time interval, wherein the second time interval lies before the first time interval.

In Example 77, the subject matter of one of the Examples 74 to 76 or any of the Examples described herein may further include, that the user equipment method includes obtaining 240 a further reference signal from the base station transceiver 100, wherein the user equipment method includes determining 250 a channel estimation for a channel between the base station transceiver 100 and the user equipment 200 based on the further reference signal, wherein the user equipment method includes refining 242 the channel estimation based on the reference signal.

In Example 78, the subject matter of one of the Examples 74 to 77 or any of the Examples described herein may further include, that the user equipment method includes determining 260 a channel quality estimation of a channel between the base station transceiver 100 and the user equipment 200, wherein the user equipment method includes providing 262 information related to the channel quality estimation to the base station transceiver 100, wherein a bandwidth of the reference signal is based on the provided information related to the channel quality estimation.

In Example 79, the subject matter of one of the Examples 74 to 78 or any of the Examples described herein may further include, that the user equipment method includes determining 270 a power delay profile based on the reference signal.

In Example 80, the subject matter of Example 79 or any of the Examples described herein may further include, that the reference signal is a periodic reference signal, wherein the user equipment method includes refining 272 the power delay profile continuously based on the periodic reference signal.

In Example 81, the subject matter of one of the Examples 79 or 80 or any of the Examples described herein may further include, that the user equipment method includes obtaining 280 a demodulation reference signal associated with the downlink control signal, wherein the user equipment method includes determining 270 the power delay profile based on the reference signal and based on the demodulation reference signal.

In Example 82, the subject matter of Example 81 or any of the Examples described herein may further include, that the demodulation reference signal is associated with a control transmission via the downlink control signal, wherein the user equipment method includes determining 270 the power delay profile based on the reference signal and based on the demodulation reference signal if a size of the control transmission is larger than a size threshold.

In Example 83, the subject matter of one of the Examples 74 to 82 or any of the Examples described herein may further include, that the user equipment method includes obtaining 290 information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the user equipment method includes obtaining 210 the reference signal based on the one or more time slots for the reference signal.

Examples further relate to a method for an entity of a mobile communication system 400. The mobile communication system 400 includes a base station transceiver 100 and a user equipment 200. The method includes determining 310 information related to a control channel configuration, wherein the control channel configuration is suitable for a control channel for a downlink control signal, wherein the information related to the control channel configuration defines one or more time-slots for a reference signal for time tracking, wherein the control channel configuration defines the reference signal and the downlink control signal to be quasi-co-located. The method includes providing 320 the information related to the control channel configuration to the base station transceiver 100 and to the user equipment 200.

In example 85, the subject matter of Example 84 or any of the Examples described herein may further include, that the reference signal is an aperiodic reference signal.

Example 86 relates to a machine readable storage medium including program code, when executed, to cause a machine to perform the method of one of the examples 61 to 84 or any of the Examples described herein.

Example 87 relates to a computer program having a program code for performing the method of at least one of the examples 61 to 84 or any of the Examples described herein, when the computer program is executed on a computer, a processor, or a programmable hardware component.

Example 88 relates to a machine readable storage including machine readable instructions, when executed, to implement a method or realize an apparatus as claimed in any pending claim or detailed in any Example.

In example 89, the subject matter of one of the Examples 1 to 13 or 31 to 43 or any of the Examples described herein may further include, that the control module 14 or the means for controlling 14 is implemented by a central processing unit XT04E of a baseband circuitry XT04, and/or wherein the at least one interface 12 or the means for communicating 12 is implemented by a radio frequency circuitry interface XU16, and/or wherein the transceiver module 16 or means for transceiving 16 is implemented by a radio frequency circuitry XT06

In example 90, the subject matter of one of the Examples 14 to 23 or 44 to 53 or any of the Examples described herein may further include, that the control module 24 or the means for controlling 24 is implemented by a central processing unit XT04E of a baseband circuitry XT04, and/or wherein the at least one interface 22 or the means for communicating 22 is implemented by a radio frequency circuitry interface XU16, and/or wherein the transceiver module 26 or means for transceiving 26 is implemented by a radio frequency circuitry XT06.

In example 91, the subject matter of one of the Examples 24, 25, 54 or 55 or any of the Examples described herein may further include, that the control module 34 or the means for controlling 34 is implemented by a central processing unit XT04E of a baseband circuitry XT04, and/or wherein the at least one interface 32 or the means for communicating 32 is implemented by a radio frequency circuitry interface XU16, and/or wherein the transceiver module 36 or means for transceiving 36 is implemented by a radio frequency circuitry XT06.

In example 92, the subject matter of one of the Examples 1 to 55 or any of the Examples described herein may further include, that the control module 14; 24; 34 or the means for controlling 14; 24; 34 is implemented by a central processing unit XT04E of a baseband circuitry XT04, and/or wherein the at least one interface 12; 22; 32 or the means for communicating 12; 22; 32 is implemented by a radio frequency circuitry interface XU16, and/or wherein the transceiver module 16; 26; 36 or means for transceiving 16; 26; 36 is implemented by a radio frequency circuitry XT06.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1.-25. (canceled)

26. An apparatus comprising:
at least one interface for communicating with a transceiver module of a base station transceiver; and
a control module configured to:
provide a reference signal to a user equipment of the mobile communication system via the transceiver module, wherein the reference signal is a reference signal for time tracking; and
provide a downlink control signal to the user equipment via the transceiver module, wherein the reference signal and the downlink control signal are quasi-co-located.

27. The apparatus according to claim 26, wherein the downlink control signal is provided via a physical downlink control channel (PDCCH) of the mobile communication system.

28. The apparatus according to claim 26, wherein the downlink control signal and the reference signal are transmitted based on the same spatial filtering parameters.

29. The apparatus according to claim 26, wherein the reference signal is one or more of:
a tracking reference signal;
a beam-formed reference signal; or
an aperiodic reference signal.

30. The apparatus according to claim 29, wherein the control module is configured to obtain information related to a control transmission to be provided to the user equipment using the downlink control signal when the reference signal is the aperiodic reference signal, wherein the aperiodic reference signal is provided based on the information related to the control transmission to be provided to the user equipment, and wherein the control module is configured to provide the control transmission to the user equipment using the downlink control signal after providing the aperiodic reference signal.

31. The apparatus according to claim 29, wherein when the reference signal is the aperiodic reference signal, the control module is configured to control a number of repetitions of the aperiodic reference signal based on a time elapsed since a previous communication with the user equipment.

32. The apparatus according to claim 26, wherein the control module is configured to obtain one or more of:
information related to a channel quality estimation of a channel between the base station transceiver and the user equipment from the user equipment via the transceiver module, wherein the control module is configured to control a bandwidth of the reference signal based on the information related to the channel quality estimation; or
information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the control module is configured to provide the reference signal based on the one or more time slots for the reference signal.

33. The apparatus of claim 26, wherein the control module is implemented by a central processing unit of a baseband circuitry;
wherein the at least one interface is implemented by a radio frequency circuitry interface; and
wherein the transceiver module is implemented by a radio frequency circuitry.

34. An apparatus comprising:
at least one interface for communicating with a transceiver module of a user equipment; and
a control module configured to:
obtain a reference signal from a base station transceiver of the mobile communication system via the transceiver module, wherein the reference signal is a reference signal for time tracking, and
obtain a downlink control signal from the base station transceiver via the transceiver module, wherein the reference signal and the downlink control signal are quasi-co-located.

35. The apparatus according to claim 34, wherein the control module is configured to decode the downlink control signal based on the obtained reference signal.

36. The apparatus according to claim 34, wherein the control module is configured to obtain the downlink control signal via the transceiver module at a first time interval if the reference signal is obtained within a second time interval, wherein the second time interval lies before the first time interval.

37. The apparatus according to claim 34, wherein the control module is configured to determine one or more of:
a channel quality estimation of a channel between the base station transceiver and the user equipment, wherein the control module is configured to provide information related to the channel quality estimation to the base station transceiver, wherein a bandwidth of the reference signal is based on the provided information related to the channel quality estimation; or
a power delay profile based on the reference signal.

38. The apparatus according to claim 37, wherein the control module is configured to obtain a demodulation reference signal associated with the downlink control signal via the transceiver module, wherein the control module is configured to determine the power delay profile based on the reference signal and based on the demodulation reference signal.

39. The apparatus according to 34, wherein the control module is configured to obtain information related to a control channel configuration for a control channel of the downlink control signal, wherein the information related to the control channel configuration defines one or more time-slots for the reference signal, wherein the control channel configuration defines the reference signal and the downlink control signal to be quasi-co-located, and wherein the control module is configured to obtain the reference signal based on the one or more time slots for the reference signal.

40. A machine readable storage medium including program code which, when executed, causes a machine to perform one or more of:
a first method comprising:
providing a reference signal to a user equipment of a mobile communication system, wherein the reference signal is a reference signal for time tracking; and
providing a downlink control signal to the user equipment, wherein the reference signal and the downlink control signal are quasi-co-located;
a second method comprising:
obtaining a reference signal from a base station transceiver of the mobile communication system, wherein the reference signal is a reference signal for time tracking; and
obtaining a downlink control signal from the base station transceiver, wherein the reference signal and the downlink control signal are quasi-co-located; or
a third method comprising:
determining information related to a control channel configuration, wherein the control channel configuration is suitable for a control channel for a downlink control signal, wherein the information related to the control channel configuration defines one or more time-slots for a reference signal for time tracking, and wherein the control channel configuration defines the reference signal and the downlink control signal to be quasi-co-located; and
providing the information related to the control channel configuration to the base station transceiver and to the user equipment.

41. The machine readable storage medium of claim 40, wherein the downlink control signal is provided and obtained via a physical downlink control channel (PDCCH) of the mobile communication system.

42. The machine readable storage medium of claim 40, wherein the downlink control signal and the reference signal are transmitted based on the same spatial filtering parameters.

43. The machine readable storage medium of claim 40, wherein the reference signal is one or more of:
a tracking reference signal;
a beam-formed reference signal; or
an aperiodic reference signal.

44. The machine readable storage medium of claim 40, wherein the second method further comprises decoding the downlink control signal based on the obtained reference signal.

45. The machine readable storage medium of claim 40, wherein the second method further comprises obtaining the downlink control signal via the transceiver module at a first time interval if the reference signal is obtained within a second time interval, wherein the second time interval lies before the first time interval.
